(19) United States
(12) Patent Application Publication
(10) Pub. No.: US 2026/0003775 A1
(43) Pub. Date: Jan. 1, 2026

(54) SEMICONDUCTOR MEMORY DEVICE AND A MEMORY SYSTEM INCLUDING THE SAME

(71) Applicant: Samsung Electronics Co., Ltd., Suwon-si (KR)

(72) Inventors: JEON IL LEE, Suwon-si (KR); JINWOO HAN, Suwon-si (KR)

(21) Appl. No.: 19/028,547

(22) Filed: Jan. 17, 2025

(30) Foreign Application Priority Data
Jun. 28, 2024 (KR) 10-2024-0085736

(51) Int. Cl. G06F 12/02

(52) U.S. Cl. CPC G06F 12/0223

(57) ABSTRACT

The present disclosure relates to a semiconductor memory device and a memory system including the same, and the semiconductor memory device includes a substrate, a plurality of banks including a first bank including a first memory cell array including a DRAM cell and a second bank including a second memory cell array including an SRAM cell, a peripheral circuit between the plurality of banks, and a processing unit adjacent to the second memory cell array.

### CROSS-REFERENCE TO RELATED APPLICATION

This application claims priority to and the benefit of Korean Patent Application No. 10-2024-0085736 filed in the Korean Intellectual Property Office on Jun. 28, 2024, the entire contents of which are incorporated herein by reference.

### BACKGROUND OF THE INVENTION

The present disclosure relates to a semiconductor device and a memory system including the same.

In a Von Neumann structure, a memory device and a computing device are provided separately, and the computing device takes data from the memory device to performing a computation. In this structure, in case that a large amount of computations are required, such as artificial neural network computations, the computing speed can be deteriorated by the time required for data transfer between the memory device and the computing device. Accordingly, a memory device of a PIM (processing in memory) structure capable of processing at least some computations within the memory device has been proposed.

### SUMMARY OF THE INVENTION

The present disclosure attempt to provide a semiconductor device having improved computation speed and a memory system including the same.

A semiconductor memory device according to some embodiments includes a substrate, a plurality of banks on the substrate and including a first bank including a first memory cell array including a DRAM cell and a second memory cell array including an SRAM cell, a peripheral circuit between the plurality of banks, and a processing unit adjacent to the second memory cell array.

A semiconductor memory device according to some embodiments includes a substrate, a plurality of banks on the substrate and including a first bank including a first memory cell array including a plurality of first cells and a second bank including a second memory cell array including a plurality of second cells, a peripheral circuit between the plurality of banks, and a processing unit adjacent to the second memory cell array, wherein a number of the plurality of second cells is less than a number of the plurality of first cells, and each of the plurality of second cells is smaller in size than each of the plurality of first cells.

A memory system according to some embodiments includes a semiconductor memory device including a plurality of banks including a first bank including a first memory cell array including a DRAM cell and a second bank including a second memory cell array including a SRAM cell, and a processing unit adjacent to the second memory cell array, and a memory controller configured to control an operation of the semiconductor memory device.

According to the embodiments, the computing process speed of semiconductor memory devices can be improved.

### BRIEF DESCRIPTION OF THE DRAWINGS

FIG. 1 is a block diagram of a memory system according to some embodiments.

FIG. 2 is a block diagram of a bank of a semiconductor memory device according to some embodiments.

FIG. 3 is a top plan view illustrating a layout of the components of a semiconductor memory device according to some embodiments.

FIG. 4 is a top plan view illustrating the connection relationship between memory cell arrays and bit lines of a semiconductor memory device according to embodiment.

FIG. 5 is a circuit diagram of a DRAM cell according to some embodiments.

FIG. 6 is a cross-sectional view of a transistor of the DRAM cell.

FIG. 7 is a circuit diagram of an SRAM cell according to some embodiments.

FIG. 8 is a cross-sectional view of a transistor of the SRAM cell.

FIG. 9 is a top plan view illustrating a layout of the components of a semiconductor memory device according to some embodiments.

FIG. 10 is a block diagram of a memory system according to some embodiments.

FIG. 11 is a block diagram of a first bank of a semiconductor memory device according to some embodiments.

FIG. 12 is a block diagram of a second bank of a semiconductor memory device according to some embodiments.

FIG. 13 is a top plan view illustrating a layout of the components of a semiconductor memory device according to some embodiments.

FIG. 14 is a top plan view illustrating a layout of the components of a semiconductor memory device according to some embodiments.

FIG. 15 is a block diagram of a memory system according to some embodiments.

FIG. 16 is a block diagram of the second bank of a semiconductor memory device according to some embodiments.

FIG. 17 is a top plan view illustrating a layout of the components of a semiconductor memory device according to some embodiments.

FIG. 18 is a cross-sectional view of a semiconductor memory device according to some embodiments.

FIG. 19 is a top plan view illustrating a layout of the components of a first core die according to some embodiments of FIG. 18.

### DETAILED DESCRIPTION OF THE EMBODIMENTS

Hereinafter, with reference to accompanying drawings, various embodiments of the present disclosure will be described in detail so that a person of an ordinary skill can easily implement the present disclosure. The present disclosure may be implemented in many different forms and is not limited to the embodiments described herein.

In order to clearly explain the present disclosure, parts that are not relevant to the description are omitted, and identical or similar components are assigned the same reference numerals throughout the specification.

In addition, the size and thickness of each component shown in the drawings are shown arbitrarily for convenience of explanation, so the present disclosure is not necessarily limited to what is shown. In the drawings, the thickness of layers, films, panels, regions, etc., are exaggerated for clarity. And in the drawings, for convenience of explanation, the thicknesses of some layers and regions are exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, being “on” or “above” a reference element refers to being positioned on or below the reference element, and does not necessarily mean being positioned “above” or “on” in a direction opposite to gravity. The term “connected” may refer to elements being physically and/or electrically connected to one another.

In addition, unless explicitly described to the contrary, the word “comprise”, and variations such as “comprises” or “comprising”, will be understood to imply the inclusion of stated elements but not the exclusion of any other elements.

In addition, throughout the specification, when referring to “a plan view” or “a plane view”, the target portion is viewed from above, and when referring to “a cross-section view”, a cross section of the target portion cut vertically is viewed from a side.

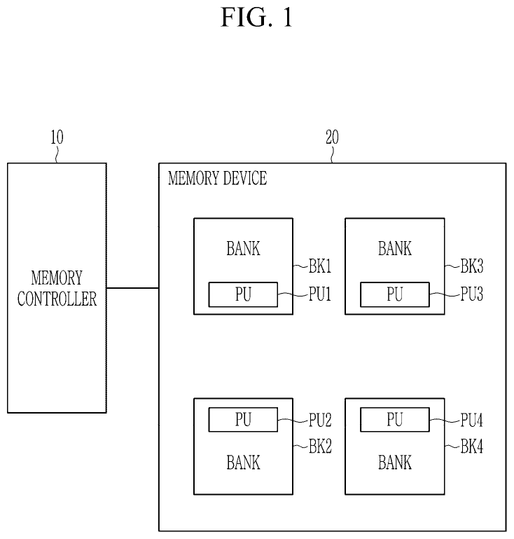

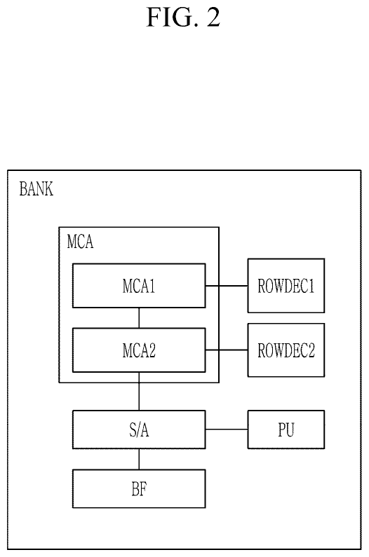

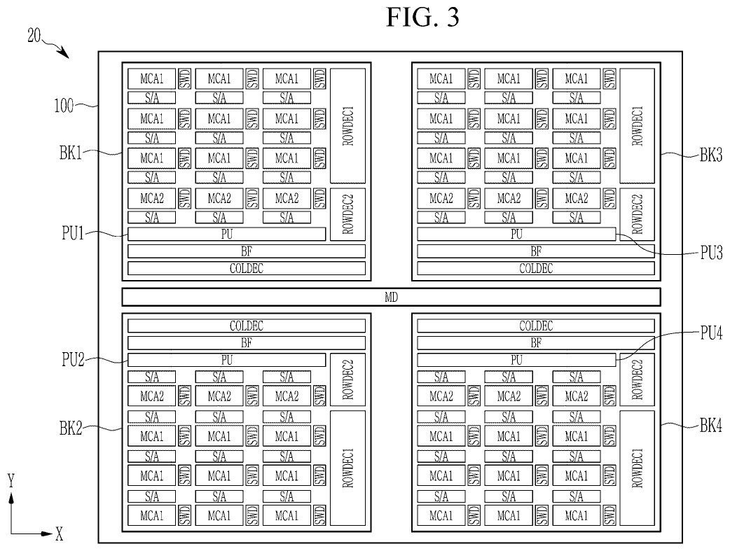

Hereinafter, referring to FIG. 1, FIG. 2, and FIG. 3, a semiconductor memory device according to some embodiments and a memory system including the same will be described.

FIG. 1 is a block diagram of a memory system according to some embodiments. FIG. 2 is a block diagram of a bank of a semiconductor memory device according to some embodiments. FIG. 3 is a top plan view illustrating a layout of the components of a semiconductor memory device according to some embodiments.

Referring to FIG. 1, a memory system may include a memory controller 10 and a semiconductor memory device 20. The memory controller 10 may control the semiconductor memory device 20 according to a request of a host. For example, the memory controller 10 may provide a command and an address to the semiconductor memory device 20 to allow the semiconductor memory device 20 to execute an operation indicated by the command, referring to the address specified by the address.

The memory controller 10 may communicate with the host using various protocols. Depending on embodiments, the memory controller 10 may be included in the host. In this case, the host may directly control the semiconductor memory device 20.

The semiconductor memory device 20 may include a processing unit PU. In other words, the semiconductor memory device 20 may be a memory device of a processing in memory (PIM) structure. The semiconductor memory device 20 may perform data read/write operations and data processing operations according to the host request and the control of the memory controller 10.

In some embodiments, the semiconductor memory device 20 may include heterogeneous memory cells. For example, the semiconductor memory device 20 may include a dynamic random access memory (DRAM) cell and a static random access memory (SRAM) cell, but not limited thereto.

Hereinafter, the semiconductor memory device 20, which includes heterogeneous memory cells and a processing unit PU, may be referred to as a hybrid PIM.

The semiconductor memory device 20 may include a bank and a processing unit PU.

The processing unit PU may be a neural processing unit NPU, but not limited thereto. Depending on embodiments, the processing unit PU may be a graphic processing unit GPU or an arithmetic logic unit ALU.

If the processing unit PU is an NPU, the processing unit PU may perform artificial neural network computations using data stored in the bank and/or data received from the host. For example, data received from the host may correspond to an input vector, and data stored in the bank may correspond to a weight matrix. The processing unit PU may perform a MAC (multiplication and accumulation) computation that multiplies the input vector and the weight matrix and sums the multiplied results.

The semiconductor memory device 20 may include a plurality of banks BK1, BK2, BK3, BK4 and a plurality of processing units PU1, PU2, PU3, PU4. Each of the plurality of processing units PU1, PU2, PU3, PU4 may be connected to one of the banks. Each of the plurality of processing units PU1, PU2, PU3, PU4 may be connected to each of the plurality of banks BK1, BK2, BK3, BK4. For example, the plurality of banks BK1, BK2, BK3, BK4 may include a first bank BK1, a second bank BK2, a third bank BK3, and a fourth bank BK4. The plurality of processing units PU1, PU2, PU3, PU4 may include a first processing unit PU1 connected to the first bank BK1, a second processing unit PU2 connected to the second bank BK2, a third processing unit PU3 connected to the third bank BK3, and a fourth processing unit PU4 connected to the fourth bank BK4.

FIG. 1 illustrates that the semiconductor memory device 20 includes four banks, but not limited thereto. The number of banks included in the semiconductor memory device 20 may be modified variously, such as 8, 16, or 32.

Referring to FIG. 2, the bank may include a memory cell array MCA, a sense amplifier S/A, a row decoder such as row decoder ROWDEC1 or row decoder ROWDEC2, and a buffer BF. FIG. 2 illustrates that the bank includes a processing unit PU, but not limited thereto. Depending on embodiments, the processing unit PU may be a component separate from the bank. The bank of FIG. 2 may be the first bank BK1, the second bank BK2, the third bank BK3, or the fourth bank BK4 of FIG. 1.

The bank may include a memory cell array MCA. The memory cell array MCA of the bank may include a first memory cell array MCA1 and a second memory cell array MCA2. The first memory cell array MCA1 and the second memory cell array MCA2 may include heterogeneous memory cells. In some embodiments, the first memory cell array MCA1 may include a DRAM cell, and the second memory cell array MCA2 may include an SRAM cell.

For example, a DRAM cell may include one transistor and one capacitor connected to the transistor, but not limited thereto. At this time, a transistor of the DRAM cell may be a metal oxide field effect transistor MOSFET, but not limited thereto. As another example, a DRAM cell may consist of one ferroelectric field effect transistor FeFET. At this time, the transistor of the DRAM cell may include a ferroelectrics layer.

For example, an SRAM cell may include two inverters coupled in parallel. Each inverter may include one pull-up transistor and one pull-down transistor coupled in series with each other. A pass gate transistor may be connected to an output terminal of each inverter. In other words, an SRAM cell may include six transistors.

Since the SRAM cell includes more transistors than a DRAM cell, it is larger in physical size than a DRAM cell. The second memory cell array MCA2, which includes the SRAM cell larger than the DRAM cell in size, may have less cells per unit area than the first memory cell array MCA1 including the DRAM cell. Since the number of cells in the first memory cell array MCA1 is greater than the number of cells in the second memory cell array MCA2 within the same or similar area, the degree of integration of the first memory cell array MCA1 may be higher than the degree of integration of the second memory cell array MCA2. In other words, more data may be stored in first memory cell array MCA1 than in second memory cell array MCA2.

The bank may include a plurality of word lines and a plurality of bit lines connected to the first memory cell array MCA1, and a plurality of word lines and a plurality of bit lines connected to the second memory cell array MCA2. Each of the plurality of word lines may extend along a row direction, and each of the plurality of bit lines may extend along a column direction. Each of the first memory cell array MCA1 and the second memory cell array MCA2 may be connected to a sense amplifier S/A through the bit line. The first memory cell array MCA1 may be connected to a first row decoder ROWDEC1 through the word lines, and the second memory cell array MCA2 may be connected to the second row decoder ROWDEC2 through the word lines.

Each of the first row decoder ROWDEC1 and the second row decoder ROWDEC2 may select a row corresponding to an address in response to the command and address (e.g. row address) received from the memory controller (such as memory controller 10 in FIG. 1). Each of the first row decoder ROWDEC1 and the second row decoder ROWDEC2 may include a word line driver applying a voltage to a word line connected to the row selected by the first row decoder ROWDEC1 and the second row decoder ROWDEC2. The voltage applied to the word line may be referred to as a gate voltage. The gate voltages turning on/off the DRAM cell and the SRAM cell may be different. The first row decoder ROWDEC1 may apply a voltage turning on/off the DRAM cell to a word line connected to a row of the first memory cell array MCA1. The second row decoder ROWDEC2 may apply a voltage turning on/off the SRAM cell to a word line connected to a row of the second memory cell array MCA2.

Each of first memory cell array MCA1 and second memory cell array MCA2 may be connected to a sense amplifier S/A through the bit lines. Although not shown, the bank may include a column decoder that selects a column corresponding to an address in response to the command and the address (e.g., column address) received from the memory controller (such as memory controller 10 in FIG. 1). The sense amplifier S/A may detect and amplify the voltage difference between a bit line pair connected to a column selected by the column decoder.

The buffer BF may temporarily store data read from the memory cell array MCA or data to be written to the memory cell array MCA. The buffer BF may be connected to the sense amplifier S/A, and may store the data detected and amplified by the sense amplifier S/A. Data stored in the buffer BF may be stored in the memory cell array MCA by a write driver. The write driver may be connected to the bit lines together with a sense amplifier S/A, and may write data to the memory cell array MCA by applying a write voltage to the bit lines. While only the sense amplifier S/A is shown in FIG. 2, the sense amplifier S/A may be used as a concept encompassing the writing driver hereinafter.

The processing unit PU may be connected to the sense amplifier S/A. The processing unit PU may include a logic circuit performing a computation. The processing unit PU may perform a computation using data detected and amplified by the sense amplifier S/A, and may store the computation results in the memory cell array MCA through the sense amplifier S/A.

Depending on embodiments, the processing unit PU may be connected to the buffer BF. In this case, the processing unit PU may perform a computation using data stored in the buffer BF. The processing unit PU may store the computation result in the buffer BF.

For example, the semiconductor memory device (such as semiconductor memory device 20 in FIG. 1) may split and store the weight matrix and input vector corresponding to an artificial neural network model received from outside or external to the semiconductor memory device 20 (e.g. from a host) in the plurality of banks (BK1, BK2, BK3, BK4 in FIG. 1). The semiconductor memory device 20 may split the weight matrix and input vector into plural and may store them in the second memory cell array MCA2 of each of the plurality of banks (BK1, BK2, BK3, BK4 in FIG. 1). The semiconductor memory device 20 may store the weight matrix and input vector directly in the second memory cell array MCA2, rather than storing them in the first memory cell array MCA1 and then transferring them to the second memory cell array MCA2.

The processing unit PU may use the second memory cell array MCA2 as a cache memory. The processing unit PU may perform a computation using data stored in the second memory cell array MCA2. The processing unit PU may store the computation result in the second memory cell array MCA2. The computation result stored in the second memory cell array MCA2 may be output to the host through the buffer BF. However, the embodiments is not necessarily limited to this example, and in some example embodiments the processing unit PU may store the computation result directly in the buffer BF.

According to the above, the semiconductor memory device 20 may store data received from a host directly in the second memory cell array MCA2, rather than through the first memory cell array MCA1. According to a comparative example that the memory cell array MCA includes only the first memory cell array MCA1 and a cache memory of the processing unit PU is provided outside or external to the bank, the semiconductor memory device 20 can perform a computation using the processing unit PU after storing data used for computation in the first memory cell array MCA1 first and then transferring the data from the first memory cell array MCA1 to the cache memory of the processing unit PU. According to some embodiments, operating process speed of the semiconductor memory device 20 may be fast since the process of storing data in the first memory cell array MCA1 and then transferring them to the second memory cell array MCA2 which is used as a cache memory of the processing unit PU, may be omitted.

For example, the semiconductor memory device 20 may store the weight matrix and the input vector not only in the second memory cell array MCA2 of each of the plurality of banks (BK1, BK2, BK3, BK4 in FIG. 1), but also in the first memory cell array MCA1. For example, the semiconductor memory device 20 may store a part of the weight matrix and/or a part of the input vector in the second memory cell array MCA2, and may store the remaining part of the weight matrix and/or the remaining part of the input vector in first memory cell array MCA1.

The processing unit PU may perform a computation using the first data stored in the second memory cell array MCA2. The processing unit PU may store the first computation result using first data in the second memory cell array MCA2. The first computation result may be output to the host through the buffer BF. Afterwards, the semiconductor memory device 20 may transfer and store the second data stored in the first memory cell array MCA1 to the second memory cell array MCA2. The processing unit PU may perform a computation using the second data stored in the second memory cell array MCA2. The processing unit PU may store the second computation result using second data in the second memory cell array MCA2. The second computation result may be output to the host through the buffer BF. By repeating such processes, the semiconductor memory device 20 may complete a computation using the weight matrix and input vector stored in the first memory cell array MCA1 and the second memory cell array MCA2.

As described above, since the second memory cell array MCA2 has low degree of integration, the amount of data available to be stored may not be large. Thus, the semiconductor memory device 20 may store data required for computation in advance in the first memory cell array MCA1, which is capable of storing more data than the second memory cell array MCA2. The semiconductor memory device 20 sequentially transfers and stores a part of the data stored in the first memory cell array MCA1 to the second memory cell array MCA2 and may sequentially perform a computation using the data stored in the second memory cell array MCA2. At this time, transferring and storing data stored in first memory cell array MCA1 to second memory cell array MCA2 may be faster than receiving data from the host and then storing it in the second memory cell array MCA2.

In the above example, it has been described that the previous computation result is output to the host before the processing unit PU performs the next computation, but not limited thereto. For example, the processing unit PU may perform a computation using the first data stored in the second memory cell array MCA2 and then may store the first computation result in the second memory cell array MCA2. The semiconductor memory device 20 may transfer and store the first computation result that is stored in the second memory cell array MCA2 to the first memory cell array MCA1. Afterwards, the semiconductor memory device 20 may transfer and store the second data stored in the first memory cell array MCA1 to the second memory cell array MCA2. The processing unit PU may perform a computation on the second data stored in second memory cell array MCA2 and then store the second computation result in second memory cell array MCA2. The semiconductor memory device 20 may transfer and store the second computation result that is stored in the second memory cell array MCA2 to the first memory cell array MCA1. Afterwards, the first computation result and second computation result stored in the first memory cell array MCA1 may be output to the host at once through the buffer BF.

In the above embodiment, the semiconductor memory device 20 may store data necessary for a computation in the second memory cell array MCA2 and may perform the computation using it. However, embodiments are not limited to that the semiconductor memory device 20 stores only the data used for a computation in the second memory cell array MCA2. The semiconductor memory device 20 may also perform general data read/write operations using the second memory cell array MCA2. For example, when the host executes an application that requires high speed operation, the semiconductor memory device 20 may write and read data used for executing the application in the second memory cell array MCA2.

FIG. 3 may be a top plan view of the semiconductor memory device 20 according to some embodiments of FIG. 1. Referring to FIG. 3, the semiconductor memory device 20 may include a substrate 100, a plurality of banks BK1, BK2, BK3, BK4, a peripheral circuit MD, and a processing unit PU.

The substrate 100 may include semiconductor material (e.g., silicon). A plurality of banks BK1, BK2, BK3, BK4 may be disposed on the substrate 100. The plurality of banks BK1, BK2, BK3, BK4 may be arranged along a first direction X and a second direction Y intersecting the first direction X. The first direction X and the second direction Y may be directions parallel to a upper surface of the substrate 100. The second direction Y may be, for example, a direction perpendicular to the first direction X.

For example, the plurality of banks BK1, BK2, BK3, BK4 may include a first bank BK1, a second bank BK2, a third bank BK3, and a fourth bank BK4. The first bank BK1 and the third bank BK3 may be arranged along the first direction X. The second bank BK2 and the fourth bank BK4 may be arranged along the first direction X. The first bank BK1 and the second bank BK2 may be arranged along the second direction Y. Third bank BK3 and fourth bank BK4 can be arranged along the second direction Y.

The peripheral circuit MD may be disposed at a periphery of the plurality of banks BK1, BK2, BK3, BK4. The peripheral circuit MD may be disposed between the plurality of banks BK1, BK2, BK3, BK4. The peripheral circuit MD may be disposed between the first bank BK1 and the second bank BK2, and between the third bank BK3 and the fourth bank BK4. The peripheral circuit MD may be disposed in a region extending along the first direction X, as a non-limiting example. The first bank BK1 and the third bank BK3 are disposed at one side of the peripheral circuit MD in the second direction Y, and the second bank BK2 and the fourth bank BK4 are disposed at the other side (e.g., opposite side) in the second direction Y.

The peripheral circuit MD may be electrically connected to the plurality of banks BK1, BK2, BK3, BK4 and the processing unit PU. The peripheral circuit MD may include a circuit controlling the plurality of banks BK1, BK2, BK3, BK4 and the processing unit PU. The peripheral circuit MD may include a command/address buffer, a control logic circuit, a data input/output buffer, etc. The command/address buffer may receive commands and addresses from the memory controller (such as memory controller 10 in FIG. 1). The control logic circuit may control access to the first memory cell array MCA1 and the second memory cell array MCA2 based on the commands and the addresses received from the memory controller 10, and may control the processing unit PU to perform a computation. The data input/output buffer may store data received from the host or data read from the plurality of banks BK1, BK2, BK3, BK4. The semiconductor memory device 20 may exchange data with the memory controller 10 through the data input/output buffer.

The semiconductor memory device 20 may include a plurality of processing units PU1, PU2, PU3, PU4. The plurality of processing units PU1, PU2, PU3, PU4 may be connected to the plurality of banks BK1, BK2, BK3, BK4, respectively. For example, the plurality of processing units PU1, PU2, PU3, PU4 may include a first processing unit PU1 connected to the first bank BK1, a second processing unit PU2 connected to the second bank BK2, a third processing unit PU3 connected to the third bank BK3, and a fourth processing unit PU4 connected to the fourth bank BK4.

FIG. 3 shows that one processing unit PU is connected to one bank, but the embodiments are not limited thereto. Depending on embodiments, a plurality of processing units PU may be connected to one bank, or one processing unit PU may be connected to a plurality of banks.

Each of the plurality of processing units PU1, PU2, PU3, PU4 may be disposed inside the plurality of banks BK1, BK2, BK3, BK4. For example, the first processing unit PU1 may be disposed inside the first bank BK1, the second processing unit PU2 may be disposed inside the second bank BK2, the third processing unit PU3 may be disposed inside the third bank BK3, and the fourth processing unit PU4 may be disposed inside the fourth bank BK4.

FIG. 3 illustrates that the processing unit PU is disposed inside the bank, but the embodiments are not limited thereto. Depending on embodiments, the processing unit PU may be disposed between the bank and the peripheral circuit MD.

Each of the plurality of banks BK1, BK2, BK3, BK4 may have a first memory cell array MCA1, a second memory cell array MCA2, a first row decoder ROWDEC1, a second row decoder ROWDEC2, a column decoder COLDEC, and a buffer BF. Each of the plurality of banks BK1, BK2, BK3, BK4 may include a plurality of first memory cell arrays MCA1 and a plurality of second memory cell arrays MCA2. The plurality of first memory cell arrays MCA1 may be arranged in a form of an array. For example, the first memory cell array MCA1 may be disposed on an upper surface of the substrate 100 to be spaced apart from each other along the first direction X and the second direction Y. For example, the second direction Y may be a direction perpendicular to the first direction X. The plurality of second memory cell arrays MCA2 may be arranged in a form of an array. FIG. 3 illustrates only that the second memory cell arrays MCA2 are disposed to be spaced apart from each other along the first direction X, but the embodiments are not limited thereto. The second memory cell arrays MCA2 may be further arranged to be spaced apart from each other along the second direction Y.

While FIG. 3 illustrates that one bank includes nine first memory cell arrays MCA1 and three second memory cell arrays MCA2, not limited thereto, the number of the first memory cell array MCA1 and the second memory cell array MCA2 which one bank includes may be modified variously. Also, while FIG. 3 shows that the plurality of first memory cell arrays MCA1 are disposed such that three of the first memory cell arrays MCA1 are arranged along each of the first direction X and second direction Y, and the plurality of second memory cell arrays MCA2 are arranged such that three of the second memory cell arrays MCA2 are arranged in the first direction X and one is arranged in second direction Y, the embodiments are not thereto. The number of plurality of first memory cell arrays MCA1 and plurality of second memory cell arrays MCA2 arranged along the first direction X and second direction Y may be modified variously.

For each of the first memory cell array MCA1 and for each of the second memory cell array MCA2, a sense amplifier S/A and a sub-word line driver SWD may be provided. The sub-word line driver SWD may apply a voltage to the word line connected to the first memory cell array MCA1 or the second memory cell array MCA2. Although not shown, the sense amplifier S/A may be connected to the first memory cell array MCA1 or the second memory cell array MCA2 through a bit line extending in the second direction Y. The sense amplifier S/A may be disposed parallel to the first memory cell array MCA1 or the second memory cell array MCA2 in the second direction Y. The sub-word line driver SWD may be connected to the first memory cell array MCA1 or the second memory cell array MCA2 through a word line extending in the first direction X. The sub-word line driver SWD may be disposed parallel to the first memory cell array MCA1 or the second memory cell array MCA2 in the first direction X.

Although not shown, the first row decoder ROWDEC1 may be connected, through the word line, to the sub-word line driver SWD connected to the first memory cell array MCA1. The second row decoder ROWDEC2 may be connected, through the word line, to the sub-word line driver SWD connected to the second memory cell array MCA2. The first row decoder ROWDEC1 may be disposed parallel to the first memory cell array MCA1 in the first direction X in which the word line extends. The second row decoder ROWDEC2 may be disposed parallel to the second memory cell array MCA2 in the first direction X in which the word line extends.

Although not shown, each of the column decoder COLDEC and the buffer BF may be connected to the first memory cell array MCA1 and the second memory cell array MCA2 through the bit line. Each of the column decoder COLDEC and the buffer BF may be arranged parallel to the first memory cell array MCA1, the second memory cell array MCA2 in the second direction Y in which the bit line extends.

While FIG. 3 illustrates that the buffer BF is closer than the column decoder COLDEC to the first memory cell array MCA1 and the second memory cell array MCA2, the embodiments are not limited thereto. Depending on embodiments, the arrangement order of the buffer BF and the column decoder COLDEC may be changed.

In some embodiments, the first memory cell array MCA1 may include a DRAM cell, and the second memory cell array MCA2 may include an SRAM cell. SRAM cells may be larger in size than DRAM cells. The second memory cell array MCA2 including SRAM cells may have less cells than the first memory cell array MCA1. The speed of access to an SRAM cell may be faster than the speed of access to a DRAM cell. The processing unit PU may use the second memory cell array MCA2 as a cache memory.

The first bank BK1 and the first processing unit PU1 will be described below, but the followings can be applies equally to the second bank BK2 and second processing unit PU2, the third bank BK3 and third processing unit PU3, and the fourth bank BK4 and fourth processing unit PU4.

In some embodiments, the first processing unit PU1 may be adjacent to the second memory cell array MCA2. In the first bank BK1, the second memory cell array MCA2 may be closer than first memory cell array MCA1 to first processing unit PU1. The distance between the second memory cell array MCA2 of first bank BK1 and the first processing unit PU1 may be shorter than the distance between the first memory cell array MCA1 of first bank BK1 and the first processing unit PU1.

In some embodiments, in first bank BK1, the second memory cell array MCA2 may be closer than the first memory cell array MCA1 to the peripheral circuit MD. The distance between the second memory cell array MCA2 of first bank BK1 and the peripheral circuit MD may be shorter than the distance between the first memory cell array MCA1 of first bank BK1 and the peripheral circuit MD.

In some embodiments, each of the plurality of banks BK1, BK2, BK3, BK4 may have a symmetrical structure with respect to the peripheral circuit MD. The plurality of banks BK1, BK2, BK3, BK4 may be disposed facing each other at one side and the other side of the peripheral circuit MD. The second memory cell arrays MCA2 of each of the banks (e.g., first bank BK1 and second bank BK2) facing each other may be disposed in a region closer than the first memory cell array MCA1 to the peripheral circuit MD. However, not limited thereto, depending on embodiments, each of the plurality of banks BK1, BK2, BK3, BK4 may have an asymmetric structure with respect to the peripheral circuit MD.

FIG. 3 illustrates that all of the plurality of banks BK1, BK2, BK3, BK4 include the first memory cell array MCA1 including DRAM cells and the second memory cell array MCA2 including SRAM cells, but the embodiments are not limited thereto. Depending on embodiments, only some of the plurality of banks BK1, BK2, BK3, BK4 may include the first memory cell array MCA1 and second memory cell array MCA2, and others may include only the first memory cell array MCA1 or only the second memory cell array MCA2.

According to some embodiments, the semiconductor memory device 20 may store the data for computation directly in the second memory cell array MCA2, rather than through the first memory cell array MCA1, and may perform a computation by the processing unit PU using the data stored in array MCA2 since each of the plurality of banks BK1, BK2, BK3, BK4 includes a first memory cell array MCA1 including a DRAM cell and a second memory cell array MCA2 including an SRAM cell, and the processing unit PU is adjacent to the second memory cell array MCA2. Thus, since the number of read/write operations of the semiconductor memory device 20 is reduced, power consumption can be reduced and operating process speed can be increased.

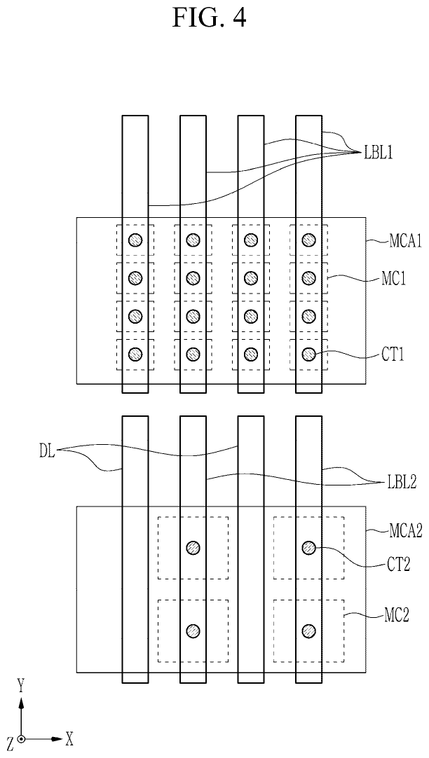

Hereinafter, the bit line connection relationship of the semiconductor memory device according to some embodiments will be described with reference to FIG. 4.

FIG. 4 is a top plan view illustrating the connection relationship between memory cell arrays and bit lines of a semiconductor memory device according to some embodiments.

The semiconductor memory device in FIG. 4 may be the semiconductor memory device 20 according to the embodiments of FIG. 1, FIG. 2, and FIG. 3. FIG. 4 illustrates the first memory cell array MCA1 and the second memory cell array MCA2 included in one bank of the semiconductor memory device. The first memory cell array MCA1 may include the first memory cell MC1, and the second memory cell array MCA2 may include the second memory cell MC2. The first memory cell MC1 may be a DRAM cell, and the second memory cell MC2 may be an SRAM cell.

Referring to FIG. 4, the second memory cell MC2 may be larger in size than the first memory cell MC1. The number of second memory cells MC2 included in the second memory cell array MCA2 may be less than the number of first memory cells MC1 included in the first memory cell array MCA1. The second memory cell array MCA2 may have a lower degree of integration than first memory cell array MCA1.

The semiconductor memory device may include a plurality of first bit lines LBL1, a plurality of second bit lines LBL2, and a plurality of dummy lines DL. The plurality of first bit lines LBL1 may traverse the first memory cell array MCA1 in the second direction Y, and the plurality of second bit lines LBL2 and the plurality of dummy lines DL may traverse the second memory cell array MCA2 in the second direction Y. The second direction Y may be a direction parallel to the upper surface of the substrate. The plurality of first bit lines LBL1 may be arranged to be spaced apart from each other in the first direction X. The plurality of second bit lines LBL2 and the plurality of dummy lines DL may be disposed to be spaced apart from each other in the first direction X. The first direction X may be a direction parallel to the upper surface of the substrate and perpendicular to the second direction Y. It is shown that the second bit line LBL2 and the dummy line DL are alternately arranged in FIG. 4, but the embodiments are not limited thereto.

In some embodiments, the number of plurality of first bit lines LBL1 may be substantially the same as the sum of the number of plurality of second bit lines LBL2 and plurality of dummy lines DL. Some of the plurality of first bit lines LBL1 may be aligned with the plurality of second bit lines LBL2 in the second direction Y. The others of plurality of first bit lines LBL1 may be aligned with the plurality of dummy lines DL in the second direction Y. In other words, some of the plurality of first bit lines LBL1 may be disposed on the same line as the plurality of second bit lines LBL2, and the others of the plurality of first bit lines LBL1 may be disposed on the same line as the plurality of dummy lines DL.

However, the embodiments are not limited thereto. Depending on embodiments, the plurality of dummy lines DL may be omitted. In this case, the number of plurality of first bit lines LBL1 may be greater than the number of plurality of second bit lines LBL2. The plurality of second bit lines LBL2 may be aligned with some of the plurality of first bit lines LBL1 in the second direction Y.

Referring to FIG. 4, the plurality of first bit lines LBL1 may be extended across the plurality of first memory cells MC1, which are disposed to be spaced apart from each other along the second direction Y. The plurality of second bit lines LBL2 may be extended across the plurality of second memory cells MC2, which are disposed to be spaced apart from each other along the second direction Y. The plurality of dummy lines DL may be extended across a region where the plurality of second memory cells MC2 are not disposed.

The plurality of first bit lines LBL1 may overlap the plurality of first memory cells MC1 in a third direction Z. The plurality of second bit lines LBL2 may overlap the plurality of second memory cells MC2 in the third direction Z. The plurality of dummy lines DL may not overlap the plurality of second memory cells MC2 in the third direction Z.

The semiconductor memory device may include a first contact CT1 connecting between the first memory cell MC1 and the first bit line LBL1, and a second contact CT2 connecting between the second memory cell MC2 and the second bit line LBL2. Each of the first contact CT1 and the second contact CT2 may be extended in the third direction Z perpendicular to the upper surface of the substrate. One end of the first contact CT1 in the third direction Z may be connected to the first bit line LBL1, and the other end in the third direction Z may be connected to the first memory cell MC1. One end of second contact CT2 in the third direction Z may be connected to second bit line LBL2, and the other end in the third direction Z may be connected to second memory cell MC2.

It is illustrated that the semiconductor memory device includes a plurality of dummy lines DL in FIG. 4, but not limited thereto, the plurality of dummy lines DL may be omitted.

According to some embodiments, in a process of manufacturing a semiconductor memory device, the plurality of second bit lines LBL2 and the plurality of dummy lines DL, which are parallel to the plurality of first bit lines LBL1 in the second direction Y, may be formed together. Since the number of the second memory cells MC2 of the second memory cell array MCA2 is less than the number of the first memory cells MC1 of the first memory cell array MCA1, the second memory cell array MCA2 may require less bit lines than the first memory cell array MCA1. Therefore, the number of the plurality of second bit lines LBL2 electrically connected to the second memory cell array MCA2 may be less than the number of the plurality of first bit lines LBL1 electrically connected to the first memory cell array MCA1. The plurality of dummy lines DL may not be electrically connected to the second memory cell array MCA2.

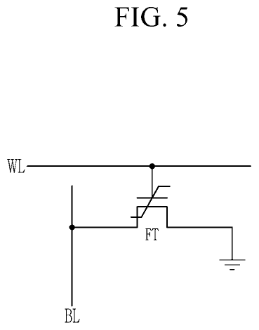

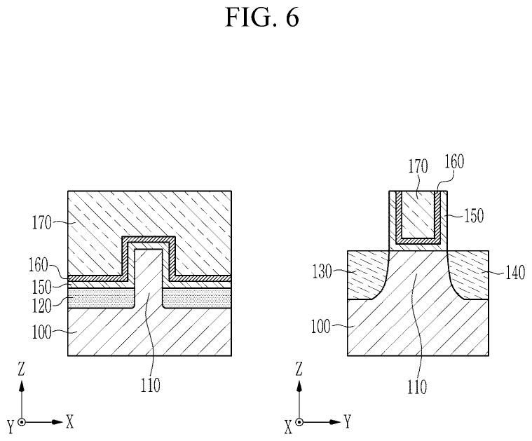

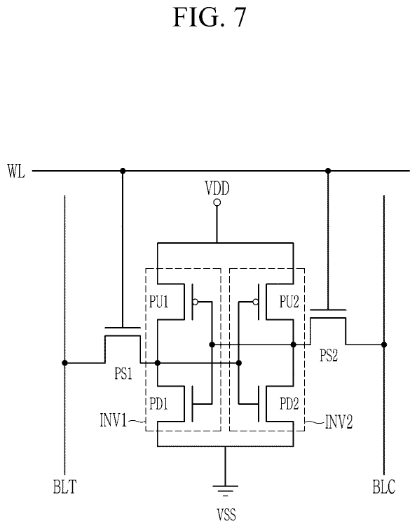

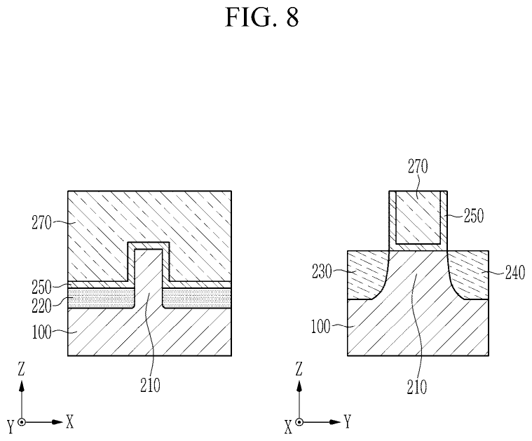

Each of the above-described first bit line LBL1 and second bit line LBL2 may be a local bit line. The local bit line may refer to a bit line connected to each memory cell array. Hereinafter, the first bit line LBL1 may be referred to as the first local bit line, and the second bit line LBL2 may be referred to as the second local bit line. A sense amplifier (S/A in FIG. 3) may be connected to the first local bit line and the second local bit line, respectively. For example, a plurality of first local bit lines may be connected to a first sense amplifier, and a plurality of second local bit lines may be connected to a second sense amplifier. Data read from the first memory cell array MCA1 through the first sense amplifier may be temporarily stored in a first local buffer, and data read from the second memory cell array MCA2 through the second sense amplifier may be temporarily stored in a second local buffer. Each of the first local buffer and the second local buffer may mean a buffer at memory cell array level, which corresponds to each of the first memory cell array MCA1 and the second memory cell array MCA2. At least part of the data stored in the first local buffer and at least part of the data stored in the second local buffer may be temporarily stored in a global buffer (BF in FIG. 3) through a global bit line. The global bit line may refer to a bit line connecting between a plurality of local buffers and a global buffer. The global buffer may refer to a buffer at bank level, which corresponds to one bank including the first memory cell array MCA1 and the second memory cell array MCA2. The part of the data stored in each of the plurality of local buffers may be selectively stored in the global buffer. Data of the first memory cell array MCA1 transmitted from the first local buffer through the global bit line and data of the second memory cell array MCA2 transmitted from the second local buffer through the global bit line may be stored together in the global buffer. Afterwards, the data of the first memory cell array MCA1 and the data of the second memory cell array MCA2 stored in the global buffer may be simultaneously transmitted to a data input/output buffer of the peripheral circuit (MD in FIG. 3). In other words, the data of the plurality of memory cell arrays included in the same bank may be stored in the global buffer and then transmitted to the peripheral circuit MD per unit of bank. The plurality of memory cell arrays included in the same bank may include the first memory cell array MCA1 and the second memory cell array MCA2, which include memory cells of different type from each other respectively. Hereinafter, a DRAM cell according to some embodiments will be described with reference to FIG. 5 and FIG. 6, and an SRAM cell according to some embodiments will be described with reference to FIG. 7 and FIG. 8.

FIG. 5 is a circuit diagram of a DRAM cell according to some embodiments. FIG. 6 is a cross-sectional view of a transistor of the DRAM cell. FIG. 7 is a circuit diagram of an SRAM cell according to some embodiments. FIG. 8 is a cross-sectional view of a transistor of the SRAM cell.

Referring to FIG. 5, a DRAM cell according to some embodiments may include a ferroelectrics field effect transistor FT. A ferroelectric field effect transistor FT is a transistor having a ferroelectrics layer added between the gate electrode and the gate insulating layer, and may generate polarization in the ferroelectrics layer by applying sufficient voltage to the gate electrode. The polarization state of the ferroelectrics layer may be maintained even if the externally applied electric field disappears. A ferroelectric field effect transistor FT may be used as a memory device that stores data using the polarization state (or polarization direction) of ferroelectrics.

A word line WL may be connected to the gate electrode of a ferroelectric field effect transistor FT. A ground terminal may be connected to the source electrode of the ferroelectric field effect transistor FT. A bit line BL may be connected to the drain electrode of the ferroelectric field effect transistor FT.

Hereinafter, the structure of the ferroelectric field effect transistor FT will be described.

Referring to FIG. 6, the ferroelectric field effect transistor FT may include a first active pattern 110, a first gate electrode 170, a ferroelectrics layer 160, and first source/drain patterns 130 and 140.

The first active pattern 110 may be defined by a first device isolation pattern 120 positioned on top of the substrate 100. The first device isolation pattern 120 may be positioned at both sides of the first active pattern 110. The first device isolation pattern 120 may include insulating material, for example, at least one of silicon oxide, silicon nitride, silicon acid nitride, or a combination thereof, but not limited thereto. The first device isolation pattern 120 may cover or overlap a lower side wall of the first active pattern 110.

The first active pattern 110 may correspond to a part of the substrate 100. The first active pattern 110 may contain semiconductor material. The first active pattern 110 may be protruded in a third direction Z perpendicular to an upper surface of the substrate 100. The first active pattern 110 may have a fin shape. A top of the first active pattern 110 may be positioned at a higher level than an upper surface of the first device isolation pattern 120. Although not shown, the first active pattern 110 may be extended in the second direction Y parallel to the upper surface of the substrate 100.

The first source/drain patterns 130, and 140 may be positioned at both sides of the first active pattern 110. The first source/drain patterns 130, and 140 may be connected to both sides of the first active pattern 110. The first source/drain patterns 130 and 140 may be extrinsic regions containing impurities of a conductivity type different from the substrate 100. A channel region may be interposed between first source/drain patterns 130, and 140.

The first gate electrode 170 may be extended in the first direction X across the first active pattern 110. The first direction X may be parallel to the upper surface of the substrate 100. The first direction X and second direction Y may be directions perpendicular to each other. The first gate electrode 170 may cover or overlap an upper surface of the first device isolation pattern 120 and a upper surface of the first active pattern 110. The first gate electrode 170 may be positioned on the first active pattern 110. The first active pattern 110 may refer to a channel region between the first source/drain patterns 130 and 140.

The first gate electrode 170 may include a conductive material. For example, the first gate electrode 170 may contains at least one of metal (e.g. tungsten, aluminum, titanium, and/or tantalum), doped semiconductor material (e.g. doped silicon), conductive metal nitride (e.g. titanium nitride, tantalum nitride, and/or tungsten nitride), or metal-semiconductor compound (e.g. metal silicide).

A ferroelectrics layer 160 may be positioned between the first active pattern 110 and the first gate electrode 170. The ferroelectrics layer 160 may have a shape that conformally covers or overlaps the first active pattern 110 and the first device isolation pattern 120. The ferroelectrics layer 160 may cover or overlap a lower surface and a side surface of the first gate electrode 170. In a cross-section along the second direction Y and third direction Z, the ferroelectrics layer 160 may have a shape of U. The ferroelectrics layer 160 may include hafnium oxide doped with at least one of, for example, zirconium, silicon, yttrium, strontium, lanthanum, gadolinium, or aluminum.

A first gate insulating layer 150 may be positioned between the first active pattern 110 and the ferroelectrics layer 160. The first gate insulating layer 150 may have a shape that conformally covers or overlaps the first active pattern 110 and the first device isolation pattern 120. The first gate insulating layer 150 may cover or overlap a lower surface and a side surface of the first gate electrode 170. In a cross-section along the second direction Y and third direction Z, the first gate insulating layer 150 may have a shape of U. The first gate insulating layer 150 may include silicon oxide, silicon nitride, silicon nitride oxide, high dielectric constant material, or combination thereof.

While the embodiments of FIG. 5 and FIG. 6 illustrates DRAM cell includes a ferroelectric field effect transistor FT, the embodiments are not limited thereto. Depending on embodiments, the DRAM cell may include a metal oxide field effect transistor and a capacitor connected to the metal oxide field effect transistor.

Referring to FIG. 7, the SRAM cell according to some embodiments may include a first inverter INV1 and a second inverter INV2 which are coupled in parallel between a power terminal (VDD) and a ground terminal (VSS), and a first pass gate transistor PS1 and a second pass gate transistor PS2 which are connected to output terminals of the first inverter INV1 and second inverter INV2. The first pass gate transistor PS1 and the second pass gate transistor PS2 may be connected to a true bit line (BLT) and a complementary bit line (BLC), respectively. The gate electrodes of the first pass gate transistor PS1 and second pass gate transistor PS2 may be connected to the word line WL.

The first inverter INV1 may include a first pull-up transistor PU1 and a first pull-down transistor PD1 which are coupled in series. The second inverter INV2 may include a second pull-up transistor PU2 and a second pull-down transistor PD2 which are coupled in series. For example, the first pull-up transistor PU1 and the second pull-up transistor PU2 may be PMOS (P-channel MOSFET) transistors, and the first pull-down transistor PD1 and second pull-down transistor PD2 may be NMOS (n-channel MOSFET) transistors.

In order for first inverter INV1 and second inverter INV2 to form one latch circuit, an input terminal of first inverter INV1 may be connected to an output terminal of second inverter INV2, and an input terminal of second inverter INV2 may be connected to an output terminal of first inverter INV1.

According to the above, the SRAM cell may include six transistors (first pull-up transistor PU1 and first pull-down transistor PD1, second pull-up transistor PU2 and second pull-down transistor PD2, first pass gate transistor PS1 and second pass gate transistor PS2) in total.

The structure of the transistor of the SRAM cell will be described below. The transistor of the SRAM cell to be described below may be at least one of the first pull-up transistor PU1, the first pull-down transistor PD1, the second pull-up transistor PU2, the second pull-down transistor PD2, the first pass gate transistor PS1, and the second pass gate transistor PS2.

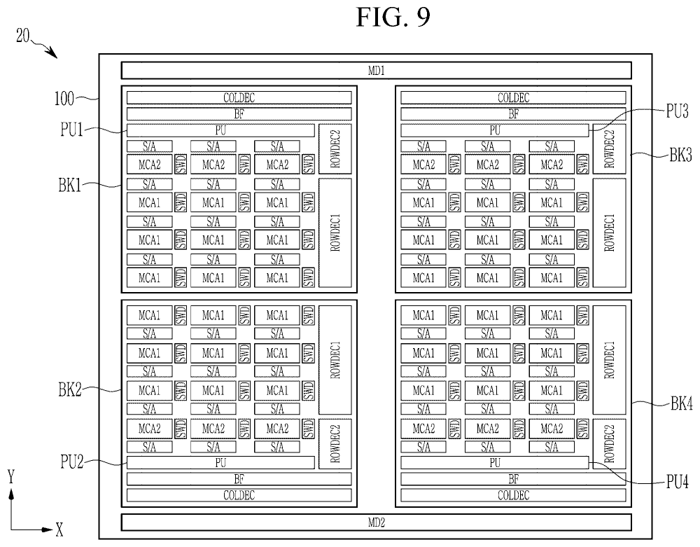

Referring to FIG. 8, the transistor of the SRAM cell may include a second active pattern 210, a second gate electrode 270, and a second source/drain patterns 230 and 240. The transistor of the SRAM cell described with reference to FIG. 9 may be a structure that the ferroelectrics layer 160 is omitted from the ferroelectrics field effect transistor FT of FIG. 7.

The second active pattern 210 may be defined by a second device isolation pattern 220 positioned on the substrate 100. The second device isolation pattern 220 may be positioned at both sides of a second active pattern 210. The second device isolation pattern 220 may include insulating material, for example, at least one of silicon oxide, silicon nitride, silicon acid nitride, or a combination thereof, but not limited thereto. The second device isolation pattern 220 may cover or overlap a lower side wall of the second active pattern 210.

The second active pattern 210 may correspond to a part of the substrate 100. The second active pattern 210 may contain semiconductor material. The second active pattern 210 may be protruded in a third direction Z perpendicular to an upper surface of the substrate 100. The second active pattern 210 may have a fin shape. A top of the second active pattern 210 may be positioned at a higher level than an upper surface of the second device isolation pattern 220. Although not shown, the second active pattern 210 may be extended in the second direction Y parallel to the upper surface of the substrate 100.

The second source/drain patterns 230, and 240 may be positioned at both sides of the second active pattern 210. The second source/drain patterns 230, and 240 may be connected to both sides of the second active pattern 210. The second source/drain patterns 230 and 240 may be extrinsic regions containing impurities of a conductivity type different from the substrate 100. A channel region may be interposed between second source/drain patterns 230, and 240.

The second gate electrode 270 may be extended in the first direction X across the second active pattern 210. The first direction X may be parallel to the upper surface of the substrate 100. The first direction X and second direction Y may be directions perpendicular to each other. The second gate electrode 270 may cover or overlap an upper surface of the second device isolation pattern 220 and a upper surface of the second active pattern 210. The second gate electrode 270 may be positioned on the second active pattern 210. The second active pattern 210 may refer to a channel region between the second source/drain patterns 230 and 240.

The second gate electrode 270 may include a conductive material. For example, the second gate electrode 270 may contains at least one of metal (e.g. tungsten, aluminum, titanium, and/or tantalum), doped semiconductor material (e.g. doped silicon), conductive metal nitride (e.g. titanium nitride, tantalum nitride, and/or tungsten nitride), or metal-semiconductor compound (e.g. metal silicide).

A second gate insulating layer 250 may be positioned between the second active pattern 210 and the second gate electrode 270. The second gate insulating layer 250 may have a shape that conformally covers or overlaps the second active pattern 210 and the second device isolation pattern 220. The second gate insulating layer 250 may cover or overlap a lower surface and a side surface of the second gate electrode 270. In a cross-section along the second direction Y and third direction Z, the second gate insulating layer 250 may have a shape of U. The second gate insulating layer 250 may include silicon oxide, silicon nitride, silicon oxynitride, high dielectric constant material, or combination thereof.

In some embodiments, the active pattern of the transistor of the DRAM cell (the first active pattern 110 of FIG. 7) and the active pattern of the transistor of the SRAM cell (the second active pattern 210 of FIG. 9) may have similar or substantially the same shapes. For example, the first active pattern 110 of FIG. 7 and the second active pattern 210 of FIG. 9 may have the same fin height. The fin height of the first active pattern 110 may refer to a height protruded from a level as same as a lower surface of the first device isolation pattern 120 in the third direction Z. The fin height of the second active pattern 210 may mean the height protruded from a level of a lower surface of the second device isolation pattern 220 in the third direction Z.

For example, the first active pattern 110 and the second active pattern 210 may be formed in the same process. Subsequently, the ferroelectrics layer 160 may be further formed only in the DRAM cell region after forming the first gate insulating layer 150 and the second gate insulating layer 250 in the same process. Next, the first gate electrode 170 and the second gate electrode 270 may be formed in the same process.

In the above example, the transistor of a DRAM cell and the transistor of an SRAM cell have a fin structure, but the embodiments are not limited thereto. For example, each of the transistor of the DRAM cell and the transistor of the SRAM cell may have GAA (Gate All Around) structure that a gate electrode surrounds the entire surface of the channel. In this case, the shapes of the active pattern and the gate electrode of each of the transistor of the DRAM cell and the transistor of the SRAM cell may be the same. For example, the diameter of the active pattern of the transistor of a DRAM cell may be the same as the diameter of the active pattern of the transistor of an SRAM cell. Additionally, when forming the transistor of a DRAM cell and the transistor of an SRAM cell, the remaining layers except the ferroelectrics layer may be formed in the same process.

In some embodiments, in case that the DRAM cell includes one ferroelectrics field effect transistor FT and does not include a capacitor, the DRAM cell and the SRAM cell may consist of only transistor. Thus, the DRAM cells and the SRAM cells may be formed simultaneously with a core circuit (e.g., the first row decoder ROWDEC1 and the second row decoder ROWDEC2, the buffer BF, and the column decoder COLDEC of FIG. 3) and a peripheral circuit (e.g., MD of FIG. 3) which include a plurality of transistors.

Hereinafter, a semiconductor memory device according to some embodiments is described with reference to FIG. 9.

FIG. 9 is a top plan view illustrating a layout of the components of a semiconductor memory device according to some embodiments. The semiconductor memory device in FIG. 9 may be a variation of the semiconductor memory device 20 according to the embodiments shown in FIG. 1, FIG. 2, and FIG. 3. Hereinafter, the description for the semiconductor of FIG. 20 will be focused on the differences from the embodiments of FIG. 1, FIG. 2, and FIG. 3, and the duplicate description will be shorten or omitted.

The semiconductor memory device 20 of FIG. 9 includes the plurality of banks BK1, BK2, BK3, BK4 and the plurality of processing units PU1, PU2, PU3, PU4 as shown in FIG. 1, and the descriptions for the bank of FIG. 2 may be equally applied to each of the plurality of banks BK1, BK2, BK3, BK4. The descriptions for the processing unit PU of FIG. 2 may be equally applied to each of the plurality of processing units PU1, PU2, PU3, PU4.

Referring to FIG. 9, the peripheral circuit MD may include a first peripheral circuit MD1 and a second peripheral circuit MD2. According to the above, the peripheral circuit MD may include a command/address buffer, a control logic circuit, a data input/output buffer, etc. Some of the components of the peripheral circuit MD may be included in the first peripheral circuit MD1, and others may be included in the second peripheral circuit MD2. Each of the plurality of banks BK1, BK2, BK3, BK4 may be electrically connected to the first peripheral circuit MD1 and the second peripheral circuit MD2.

In some embodiments, the plurality of banks BK1, BK2, BK3, BK4 may be disposed between the first peripheral circuit MD1 and the second peripheral circuit MD2. The first peripheral circuit MD1 and the second peripheral circuit MD2 may be arranged to be spaced apart with a plurality of banks BK1, BK2, BK3, BK4 interposed therebetween. Each of the first peripheral circuit MD1 and the second peripheral circuit MD2 may be disposed in a region extended along the first direction X. For example, between first peripheral circuit MD1 and second peripheral circuit MD2, the first bank BK1 and the second bank BK2 may be arranged along the second direction Y, and the third bank BK3 and the fourth bank BK4 may be disposed along the second direction Y. Between the first peripheral circuit MD1 and the second peripheral circuit MD2, the first bank BK1 and the third bank BK3 may be arranged along the first direction X, and the second bank BK2 and the fourth bank BK4 may be disposed along the first direction X. For example, the first bank BK1 and the third bank BK3 may be disposed adjacent to the first peripheral circuit MD1, and the second bank BK2 and the fourth bank BK4 may be disposed adjacent to the second peripheral circuit MD2.

In each of the first bank BK1 and the third bank BK3, which are adjacent to the first peripheral circuit MD1, among the plurality of banks BK1, BK2, BK3, BK4, the second memory cell array MCA2 may be closer than first memory cell array MCA1 to first peripheral circuit MD1. Among the plurality of banks BK1, BK2, BK3, BK4, the second memory cell array MCA2 of each of the second bank BK2 and the fourth bank BK4 adjacent to the second peripheral circuit MD2 may be closer than the first memory cell array MCA1 to the second peripheral circuit MD2.

In some embodiments, arrangement of the first memory cell array MCA1 and the second memory cell array MCA2 of each of the plurality of banks BK1, BK2, BK3, BK4 may have a symmetrical structure with respect to a region, which is extended in the first direction X between the first bank BK1 and the second bank BK2 and between the third bank and the fourth bank BK4, on the substrate.

In the embodiment of FIG. 3, the peripheral circuit MD and plurality of processing units PU1, PU2, PU3, PU4 may be disposed, on the substrate 100, in a center portion of a region where the plurality of banks BK1, BK2, BK3, BK4 are disposed. Accordingly, in each of the plurality of banks BK1, BK2, BK3, BK4, the second memory cell array MCA2 may be disposed adjacent to the center.

Unlike the embodiment of FIG. 3, in the embodiment of FIG. 9, the first peripheral circuit MD1, the second peripheral circuit MD2 and the plurality of processing units PU1, PU2, PU3, PU4 may be disposed, on the substrate 100, at an edge portion of a region where the plurality of banks BK1, BK2, BK3, BK4 are disposed. Accordingly, in each of the plurality of banks BK1, BK2, BK3, BK4, the second memory cell array MCA2 may be disposed adjacent to the edge portion.

The bank is shown as being disposed only between the first peripheral circuit MD1 and the second peripheral circuit MD2 in FIG. 9, but the embodiments are not limited thereto. Depending on embodiments, a bank may be further disposed at an upper side of the first peripheral circuit MD1 and at a lower side of the second peripheral circuit MD2.

The embodiment of FIG. 9 is different from the embodiment of FIG. 3 only in that the peripheral circuits MD are separated and spaced apart from each other, and may have the same effects as the embodiment of FIG. 3. According to some embodiments, the semiconductor memory device 20 may store the data for computation directly in the second memory cell array MCA2, rather than through the first memory cell array MCA1, and may perform a computation by the processing unit PU using the data stored in array MCA2 since each of the plurality of banks BK1, BK2, BK3, BK4 includes a first memory cell array MCA1 including a DRAM cell and a second memory cell array MCA2 including an SRAM cell, and the processing unit PU is adjacent to the second memory cell array MCA2. According to this, since the number of read/write operations of the semiconductor memory device 20 is reduced, power consumption can be reduced and operating process speed can be increases.

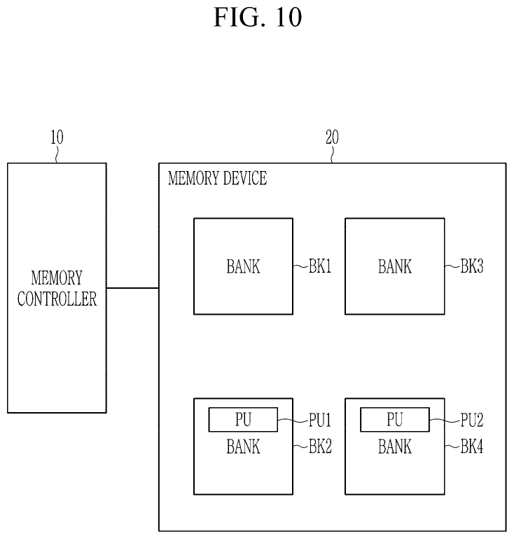

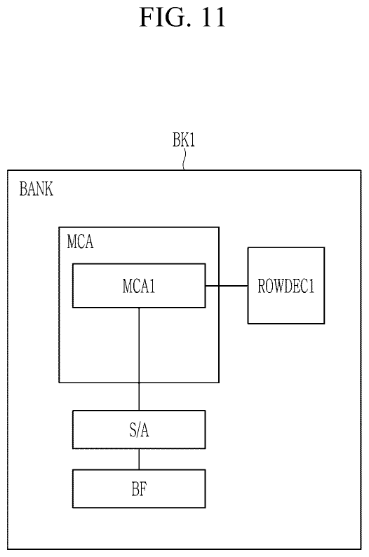

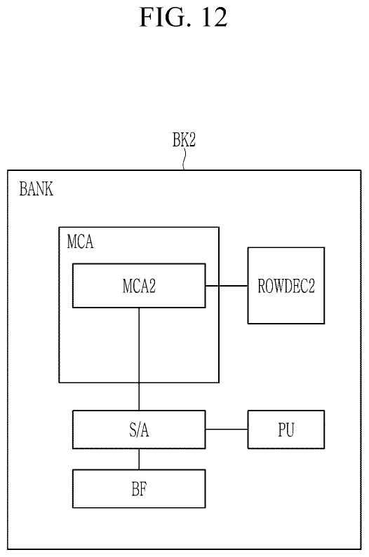

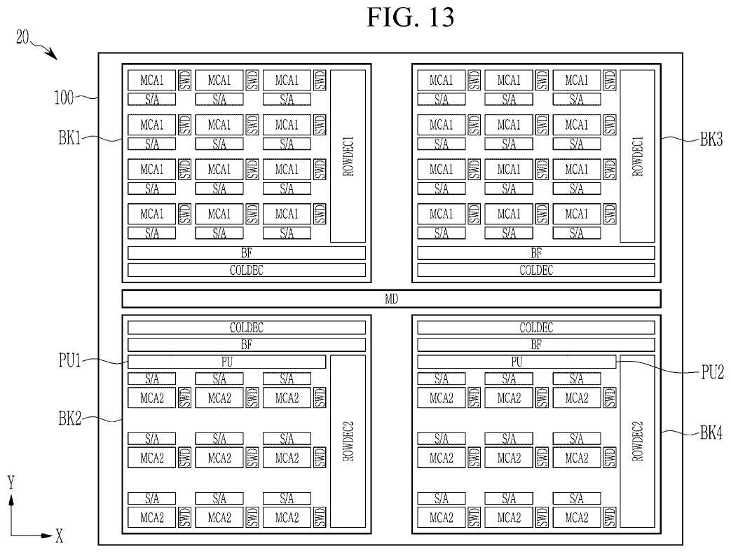

Hereinafter, a semiconductor memory device according to some embodiments and a memory system including the same will be described with reference to FIG. 10, FIG. 11, FIG. 12, and FIG. 13.

FIG. 10 is a block diagram of a memory system according to some embodiments. FIG. 11 is a block diagram of a first bank of a semiconductor memory device according to some embodiments. FIG. 12 is a block diagram of a second bank of a semiconductor memory device according to some embodiments. FIG. 13 is a top plan view illustrating a layout of the components of a semiconductor memory device according to some embodiments. Hereinafter, the description for a semiconductor memory device of FIG. 10, FIG. 11, FIG. 12, and FIG. 13 and a memory system including the same will be focused on the differences from the semiconductor memory device of FIG. 1, FIG. 2, and FIG. 3 and a memory system including the same, and the duplicate description will be shorten or omitted.

Referring to FIG. 10, a memory system may include a memory controller 10 and a semiconductor memory device 20. The semiconductor memory device 20 may include a plurality of banks BK1, BK2, BK3, BK4 and a plurality of processing units PU1, PU2. Each of the plurality of processing units PU1, PU2 may be connected to one of the banks. Each of the plurality of processing units PU1, PU2 may be connected to some of the plurality of banks BK1, BK2, BK3, BK4. For example, the plurality of banks BK1, BK2, BK3, BK4 may include a first bank BK1, a second bank BK2, a third bank BK3, and a fourth bank BK4. The plurality of processing units PU1 and PU2 may include a first processing unit PU1 connected to the second bank BK2, and a second processing unit PU2 connected to the fourth bank BK4.

FIG. 10 illustrates that the processing unit PU are connected only to second bank BK2 and fourth bank BK4 among the plurality of banks BK1, BK2, BK3, BK4, but the embodiments are not limited thereto. For example, the semiconductor memory device 20 may further include processing unit PU respectively connected to first bank BK1 and third bank BK3 which include the first memory cell array MCA1. As another example, one processing unit PU of the semiconductor memory device 20 may be connected to both the first bank BK1 including first memory cell array MCA1 and the second bank BK2 including second memory cell array MCA2.

Hereinafter, among the plurality of banks BK1, BK2, BK3, BK4, the first bank BK1 which is not connected to the processing unit PU and the second bank BK2 which is connected to the processing unit PU will be described with reference to FIG. 11 and FIG. 12. The second bank BK2 is shown as including a processing unit PU in FIG. 12, but the embodiments are not limited thereto. Depending on embodiments, the processing unit PU may be a component separate from the second bank BK2. The description for the first bank BK1 may be equally applied to the third bank BK3, and the description for the second bank BK2 may be equally applied to the fourth bank BK4.

The first bank BK1 may include a memory cell array MCA. The memory cell array MCA of the first bank BK1 may include a first memory cell array MCA1. The first memory cell array MCA1 may include a DRAM cell. The first bank BK1 may include a plurality of word lines and a plurality of bit lines connected to the first memory cell array MCA1. The first memory cell array MCA1 may be connected to a sense amplifier S/A through the bit lines and may be connected to a first row decoder ROWDEC1 through the word lines.

The first row decoder ROWDEC1 may select a row corresponding to an address in response to a command and an address (e.g. row address) received from the memory controller (10 in FIG. 10). The first row decoder ROWDEC1 may include a word line driver applying a voltage to the word line connected to the row selected by the first row decoder ROWDEC1. The first row decoder ROWDEC1 may apply a voltage turning on/off the DRAM cell to a word line connected to a row of the first memory cell array MCA1.

Although not shown, the first bank BK1 may include a column decoder that selects a column corresponding to an address in response to the command and the address (e.g., column address) received from the memory controller 10. The sense amplifier S/A may detect and amplify the voltage difference between a bit line pair connected to a column selected by the column decoder.

The buffer BF may temporarily store data read from the first memory cell array MCA1 or data to be written to the first memory cell array MCA1. The buffer BF may be connected to the sense amplifier S/A, and may store the data detected and amplified by the sense amplifier S/A. Data stored in the buffer BF may be stored in the first memory cell array MCA1 by a write driver. The write driver may be connected to the bit lines together with a sense amplifier S/A, and the write driver may write data to the first memory cell array MCA1 by applying a write voltage to the bit lines. While only the sense amplifier S/A is shown in FIG. 9, hereinafter, the sense amplifier S/A may be used as a concept encompassing the writing driver.

The second bank BK2 may include a memory cell array MCA. The memory cell array MCA of the second bank BK2 may include a second memory cell array MCA2. The second memory cell array MCA2 may include SRAM cells. The speed of access to SRAM cells may be faster than the speed of access to DRAM cells. SRAM cells may be larger in size than DRAM cells. The second memory cell array MCA2, which includes SRAM cells having a size larger than DRAM cells, may have less cells than the first memory cell array MCA1 including DRAM cells.

The second bank BK2 may include a plurality of word lines and a plurality of bit lines connected to the second memory cell array MCA2. The second memory cell array MCA2 may be connected to the sense amplifier S/A through the bit lines and may be connected to the second row decoder ROWDEC2 through the word lines.

The second row decoder ROWDEC2 may select a row corresponding to an address in response to the command and address (e.g. row address) received from the memory controller 10. The second row decoder ROWDEC2 may include a word line driver applying a voltage to the word line connected to the row selected by the second row decoder ROWDEC2. The second row decoder ROWDEC2 may apply a voltage turning on/off the DRAM cell to a word line connected to a row of the second memory cell array MCA2.

The second bank BK2 may include a column decoder, and the description for the column decoder of first bank BK1 may be equally applied thereto.

The buffer BF may temporarily store data read from the second memory cell array MCA2 or data to be written to the second memory cell array MCA2. The buffer BF may be connected to the sense amplifier S/A, and may store the data detected and amplified by the sense amplifier S/A. Data stored in the buffer BF may be stored in the second memory cell array MCA2 through the write driver. The write driver may be connected to the bit lines together with a sense amplifier S/A, and the write driver may write data to the second memory cell array MCA2 by applying a write voltage to the bit lines. While only the sense amplifier S/A is shown in FIG. 10, hereinafter, the sense amplifier S/A may be used as a concept encompassing the writing driver.

A processing unit PU may be connected to second bank BK2. The processing unit PU may be connected to the sense amplifier S/A. The processing unit PU may include a logic circuit performing a computation. The processing unit PU may perform a computation using data detected and amplified by the sense amplifier S/A. According to the above, since the speed of access to SRAM cells is faster than the speed access to DRAM cells, the processing unit PU may use the second bank BK2, which includes the second memory cell array MCA2 including SRAM cells, as cache memory.

The processing unit PU may store a computation result in the second memory cell array MCA2 through the detection amplifier S/A, but not limited thereto. Depending on embodiments, the processing unit PU may be connected to the buffer BF. In this case, the processing unit PU may perform a computation using data stored in the buffer BF. The processing unit PU may store the computation result in the buffer BF.

For example, the semiconductor memory device (such as semiconductor memory device 20 in FIG. 1) may store the weight matrix and input vector corresponding to an artificial neural network model received from outside or external to the semiconductor memory device 20 (e.g. a host) in the second bank BK2. The second bank BK2 may be a bank including a second memory cell array MCA2 including an SRAM cell. If the bank including the second memory cell array MCA2 including the SRAM cell is plural, the semiconductor memory device 20 may split and store the weight matrix and the input vector in the plurality of banks. In some embodiments, the second bank BK2 and the fourth bank BK4 of the semiconductor memory device 20 may include a second memory cell array MCA2 including an SRAM cell. The semiconductor memory device 20 may store a part of the weight matrix and input vector in the second memory cell array MCA2 of the second bank BK2, and may store the remaining part in the second memory cell array MCA2 of the fourth bank BK4.

The plurality of processing units PU1, and PU2 may perform computations using data stored in the second bank BK2 and the fourth bank BK4. The first processing unit PU1 may perform a computation using the first data stored in second bank BK2 and may store a first computation result in the second bank BK2. The second processing unit PU2 may perform a computation using second data stored in the fourth bank BK4 and store a second computation result in the fourth bank BK4. The first computation result may be output to the host through the buffer BF of the second bank BK2, and the second computation result may be output to the host through a buffer BF of the fourth bank BK4. The first computation result and the second computation result may be temporarily stored in the buffer BF of the second bank BK2 and the buffer BF of the fourth bank BK4, respectively, and then may be simultaneously output to the host.

In some embodiments, the plurality of banks BK1, BK2, BK3, BK4 of the semiconductor memory device 20 may include a first bank BK1 and a third bank BK3 including first memory cell array MCA1 including DRAM cell, and a second bank BK2 and a fourth bank BK4 including second memory cell array MCA2 including SRAM cell. Each memory cell array MCA of first bank BK1 and third bank BK3 may include only the first memory cell array MCA1, and may not include the second memory cell array MCA2. The memory cell array MCA of each of the second bank BK2 and the fourth bank BK4 may include only the second memory cell array MCA2, and may not include the first memory cell array MCA1.

In some embodiments, the plurality of processing units PU1 and PU2 of the semiconductor memory device 20 may include a first processing unit PU1 and a second processing unit PU2 respectively connected to the second bank BK2 and fourth bank BK4 including a second memory cell array MCA2. The processing unit PU may not be connected to the first bank BK1 and the third bank BK3 which include the first memory cell array MCA1.

In some embodiments, the semiconductor memory device 20 may perform a computation using data stored in the second bank BK2 and fourth bank BK4, which includes the second memory cell array MCA2 including the SRAM cell, among the plurality of banks BK1, BK2, BK3, BK4. However, the embodiments are not limited to that the semiconductor memory device 20 stores only the data used for computation in the second bank BK2 and the fourth bank BK4. The semiconductor memory device 20 may read data stored in the plurality of banks BK1, BK2, BK3, BK4 or write data to the plurality of banks BK1, BK2, BK3, BK4. For example, when the host executes an application that requires high speed operation, the semiconductor memory device 20 may read and write data used for executing the application from and in the second bank BK2 and fourth bank BK4, which include the second memory cell array MCA2 including the SRAM cell, among the plurality of banks BK1, BK2, BK3, BK4.

In some embodiments, the memory controller (10 in FIG. 10) and the semiconductor memory device 20 may be connected through one channel. In other words, a plurality of banks BK1, BK2, BK3, BK4 of semiconductor memory devices 20 may be connected to one channel. For example, the memory controller 10 may control the semiconductor memory device 20 in a first mode that performs general data read/write operations, or in a second mode that performs a computation using the processing unit PU. The semiconductor memory device 20 may use all of the plurality of banks BK1, BK2, BK3, BK4 in the first mode, and may use the second bank BK2 and fourth bank BK4, which include the second memory cell array MCA2 and are connected to the processing unit PU, among the plurality of banks BK1, BK2, BK3, BK4 in the second mode.

However, the embodiments are not limited to the above. Depending on embodiments, the memory controller 10 and the semiconductor memory device 20 may be connected through two channels. For example, the memory controller 10 may be connected to first bank BK1 and third bank BK3, which include the first memory cell array MCA1, through a first channel, and may be connected to the second bank BK2 and fourth bank BK4, which include the second memory cell array MCA2 and are connected to the processing unit PU, through a second channel. The semiconductor memory device 20 may simultaneously control the banks connected to the first channel and the banks connected to the second channel in different modes. For example, the memory controller 10 may access the first bank BK1 and third bank BK3 through the first channel, and may access second bank BK2 and fourth bank BK4 through the second channel. Access through the first channel and access through the second channel may be performed independently. The semiconductor memory device 20 simultaneously may read or write data from or to first bank BK1 and third bank BK3 including first memory cell array MCA1, and may perform a computation using data stored in the second bank BK2 and the fourth bank BK4 including second memory cell array MCA2.

Referring to FIG. 13, plurality of banks BK1, BK2, BK3, BK4 may be disposed on a substrate 100. For example, the first bank BK1 and the third bank BK3 may be arranged along the first direction X. The second bank BK2 and the fourth bank BK4 may be arranged along the first direction X. The first bank BK1 and the second bank BK2 may be arranged along the second direction Y intersecting the first direction X. Third bank BK3 and the fourth bank BK4 may be arranged along the second direction Y. The second direction Y may be, for example, a direction perpendicular to the first direction X.

The peripheral circuit MD may be disposed between the plurality of banks BK1, BK2, BK3, BK4. The peripheral circuit MD may be disposed between the first bank BK1 and the second bank BK2, and between the third bank BK3 and the fourth bank BK4. The peripheral circuit MD may be disposed in a region extending along the first direction X. The first bank BK1 and the third bank BK3 are disposed at one side of the peripheral circuit MD in the second direction Y, and the second bank BK2 and the fourth bank BK4 are disposed at the other side (e.g., opposite side) in the second direction Y.

However, not limited thereto, as the embodiment of FIG. 9, the peripheral circuit MD may be split into a first peripheral circuit MD1 and a second peripheral circuit MD2 to be arranged spaced apart from each other with the plurality of banks BK1, BK2, BK3, BK4 interposed therebetween. For example, the first peripheral circuit MD1 may be disposed at an upper side of the first bank BK1 and the third bank BK3, and the second peripheral circuit MD2 may be disposed at a lower side of the second bank BK2 and the fourth bank BK4.

In some embodiments, the first bank BK1 and the third bank BK3 may include a first memory cell array MCA1 including the DRAM cell, and the second bank BK2 and the fourth bank BK4 may include a second memory cell array MCA2 including the SRAM cell.

In some embodiments, the plurality of processing units PU1 and PU2 may be disposed inside the second bank BK2 and the fourth bank BK4 including the second memory cell array MCA2. For example, the first processing unit PU1 may be disposed inside the second bank BK2, and the second processing unit PU2 may be disposed inside the fourth bank BK4.

However, the embodiments are not limited to the processing unit PU being disposed inside the bank. In some embodiments that a processing unit PU is disposed outside, the first processing unit PU1 may be disposed between the second bank BK2 and the peripheral circuit MD, and the second processing unit PU2 may be disposed between the fourth bank BK4 and the peripheral circuit MD.

In some embodiments, the plurality of banks BK1, BK2, BK3, BK4 may have an asymmetric structures with respect to the peripheral circuit MD. For example, the first bank BK1 and the third bank BK3 which include the first memory cell array MCA1 may be disposed to face the second bank BK2 and fourth bank BK4 which including second memory cell array MCA2, with a peripheral circuit MD interposed therebetween.

According to some embodiments, the plurality of banks BK1, BK2, BK3, BK4 include a plurality of banks including a first bank BK1 and a second bank. The first bank BK1 includes a first memory cell array MCA1 including DRAM cells and does not include a second memory cell array MCA2 including SRAM cells. The second bank BK2 includes the second memory cell array MCA2 and does not include the first memory cell array MCA1. The processing unit PU is adjacent to the second memory cell array MCA2. Accordingly, the semiconductor memory device 20 may store data used for computation directly in the second memory cell array MCA2, rather than through the first memory cell array MCA1, and may perform a computation using the data stored in the through the processing unit PU. According to this, the number of read/write operations of the semiconductor memory device 20 is reduced, power consumption can be reduced and operating process speed can be increased.

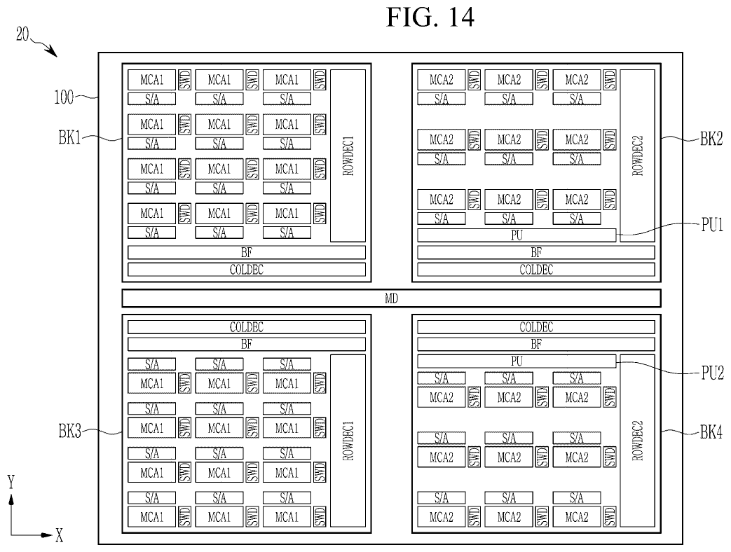

Hereinafter, a semiconductor memory device according to some embodiments is described with reference to FIG. 14.

FIG. 14 is a top plan view illustrating a layout of the components of a semiconductor memory device according to some embodiments. FIG. 14 may be a variation of the semiconductor memory device 20 according to the embodiments of FIG. 10, FIG. 11, FIG. 12, and FIG. 13. Hereinafter, the description for the semiconductor of FIG. 14 will be focused on the differences from the embodiments of FIG. 10, FIG. 11, FIG. 12, and FIG. 13, and the duplicate description will be shorten or omitted.

The semiconductor memory device 20 of FIG. 14 may include a plurality of banks BK1, BK2, BK3, BK4 and a plurality of processing units PU1, PU2, PU3, PU4 as shown in FIG. 8. The description for the bank of FIG. 11 may be equally applied to the first bank BK1 and the third bank BK3 among the plurality of banks BK1, BK2, BK3, BK4. The description for the bank of FIG. 12 may be equally applied to the second bank BK2 and the fourth bank BK4 among the plurality of banks BK1, BK2, BK3, BK4. Among the plurality of processing units PU1 and PU2, the first processing unit PU1 may be connected to the second bank BK2, and the second processing unit PU2 may be connected to the fourth bank BK4. The description for the processing unit PU of FIG. 12 may be equally applied to each of the first processing unit PU1 and the second processing unit PU2.

Referring to FIG. 14, plurality of banks BK1, BK2, BK3, BK4 may be disposed on a substrate 100. For example, the first bank BK1 and the second bank BK2 may be arranged along the first direction X. The third bank BK3 and the fourth bank BK4 may be arranged along the first direction X. The first bank BK1 and the third bank BK3 may be arranged along the second direction Y intersecting the first direction X. The second bank BK2 and the fourth bank BK4 may be arranged along the second direction Y. The second direction Y may be, for example, a direction perpendicular to the first direction X.

The peripheral circuit MD may be disposed between the plurality of banks BK1, BK2, BK3, BK4. The peripheral circuit MD may be disposed between the first bank BK1 and the third bank BK3, and between the second bank BK2 and the fourth bank BK4. The peripheral circuit MD may be disposed in a region extending along the first direction X. The first bank BK1 and the second bank BK2 are disposed at one side of the peripheral circuit MD in the second direction Y, and the third bank BK3 and the fourth bank BK4 are disposed at the other side (e.g., opposite side) in the second direction Y.

However, not limited thereto, as the embodiment of FIG. 9, the peripheral circuit MD may be split into a first peripheral circuit MD1 and a second peripheral circuit MD2 to be arranged spaced apart from each other with the plurality of banks BK1, BK2, BK3, BK4 interposed therebetween. For example, the first peripheral circuit MD1 may be disposed at an upper side of the first bank BK1 and the second bank BK2, and the second peripheral circuit MD2 may be disposed at a lower side of the third bank BK3 and the fourth bank BK4.

In the embodiment of FIG. 14, the first bank BK1 and the third bank BK3 may include the first memory cell array MCA1 including DRAM cell, and the second bank BK2 and the fourth bank BK4 may include the second memory cell array MCA2 including SRAM cell. The plurality of processing units PU1 and PU2 may be disposed inside the second bank BK2 and fourth bank BK4 including second memory cell array MCA2. For example, the first processing unit PU1 is disposed inside the second bank BK2, and the second processing unit PU2 may be disposed inside the fourth bank BK4.

However, the embodiments are not limited to the processing unit PU being disposed inside the bank. In some embodiments that a processing unit PU is disposed outside, the first processing unit PU1 may be disposed between the second bank BK2 and the peripheral circuit MD, and the second processing unit PU2 may be disposed between the fourth bank BK4 and the peripheral circuit MD.

In the embodiment of FIG. 14, unlike the embodiment in FIG. 13, the plurality of banks BK1, BK2, BK3, BK4 may have a structure symmetric with respect to the peripheral circuit MD. For example, the first bank BK1 and the third bank BK3 which include the first memory cell array MCA1 may be arranged to face each other with a peripheral circuit MD interposed therebetween. The second bank BK2 and the fourth bank BK4 which include the second memory cell array MCA2 may be arranged to face each other with a peripheral circuit MD interposed therebetween.

The embodiment of FIG. 14 is different only in that the plurality of banks BK1, BK2, BK3, BK4 are disposed symmetrically with respect to the peripheral circuit MD, and the embodiment of FIG. 14 may have the same effects as the embodiment of FIG. 13. The semiconductor memory device 20 of FIG. 14 may include a plurality of banks including a first bank BK1, a second bank BK2, and a processing unit PU. The first bank BK1 includes a first memory cell array MCA1 including a DRAM and does not include a second memory cell array MCA2 including an SRAM cell. The second bank BK2 includes the second memory cell array MCA2 and does not include the first memory cell array MCA1. The processing unit is adjacent to the second memory cell array MCA2. According to this, the semiconductor memory device 20 stores the data used for computation directly in the second memory cell array MCA2, rather than through the first memory cell array MCA1 and performs a computation using the data stored in the second memory cell array MCA2, which can save power consumption and increase operating process speed.

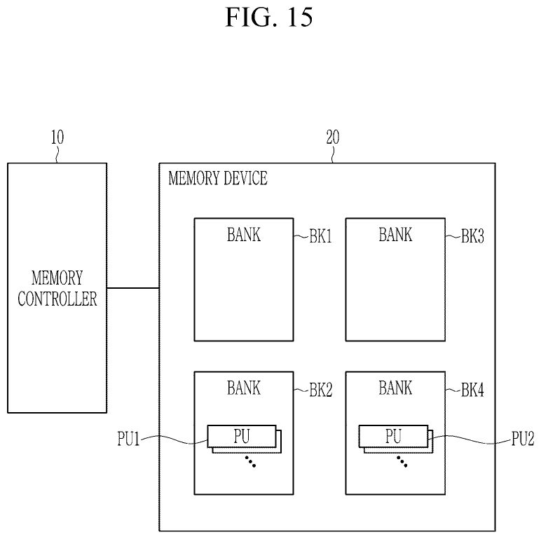

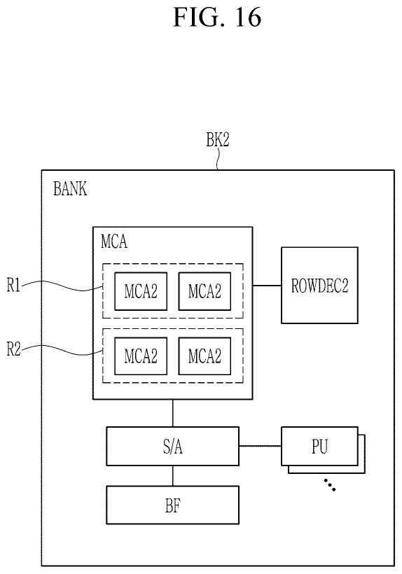

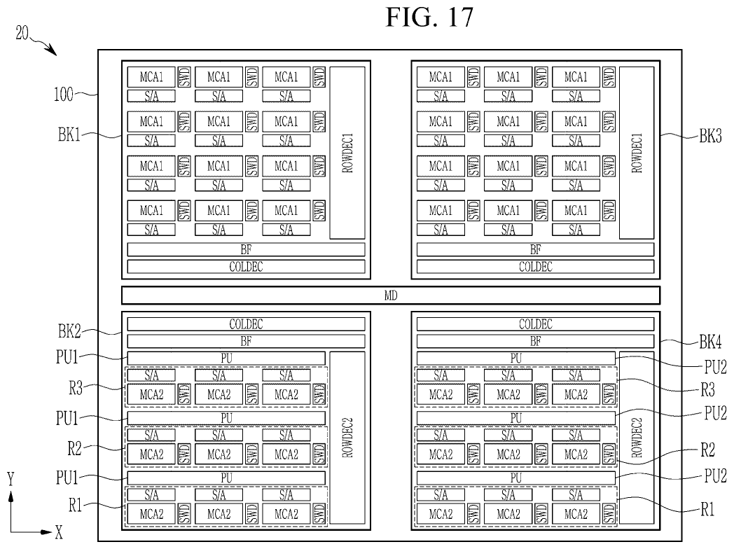

Hereinafter, referring to FIG. 15, FIG. 16, and FIG. 17, a semiconductor memory device according to some embodiments and a memory system including the same will be described.

FIG. 15 is a block diagram of a memory system according to some embodiments. FIG. 16 is a block diagram of the second bank of a semiconductor memory device according to some embodiments. FIG. 17 is a top plan view illustrating a layout of the components of a semiconductor memory device according to some embodiments. Hereinafter, the description for a semiconductor memory device of FIG. 15, FIG. 16, and FIG. 17 and a memory system including the same will be focused on the differences from the semiconductor memory device of FIG. 10, FIG. 11, FIG. 12, and FIG. 13 and a memory system including the same, and the duplicate description will be shorten or omitted.

Referring to FIG. 15, a memory system may include a memory controller 10 and a semiconductor memory device 20. The semiconductor memory device 20 may include a plurality of banks BK1, BK2, BK3, BK4 and a processing units PU. The processing unit PU may not connected to a first bank BK1 and a third bank BK3 among the plurality of banks BK1, BK2, BK3, BK4, and the processing unit PU may be connected to a second bank BK2 and a fourth bank BK4 among the plurality of banks BK1, BK2, BK3, BK4. In some embodiments, a plurality of processing units PU may be connected to one bank. A plurality of first processing unit PU1 may be connected to the second bank BK2, and a plurality of second processing unit PU2 may be connected to the fourth bank BK4.

FIG. 15 illustrates that the processing unit PU is connected only to the second bank BK2 and fourth bank BK4 among the plurality of banks BK1, BK2, BK3, BK4, but the embodiments are not limited thereto. For example, the semiconductor memory device 20 may further include processing unit PU respectively connected to first bank BK1 and third bank BK3 including the first memory cell array MCA1. As another example, one processing unit PU of the semiconductor memory device 20 may be connected to both the first bank BK1 including first memory cell array MCA1 and the second bank BK2 including second memory cell array MCA2.

Hereinafter, among the plurality of banks BK1, BK2, BK3, BK4, the second bank BK2 connected to the plurality of processing units PU will be described with reference to FIG. 16. The above description with reference to FIG. 11 may be equally applied to the first bank BK1, to which no processing unit PU is connected, among the plurality of banks BK1, BK2, BK3, BK4. The above description for the first bank BK1 with reference to FIG. 11 may be equally applied to the third bank BK3. The description for the second bank BK2 to be described below with reference to FIG. 16 may be equally applied to the fourth bank BK4.

The second bank BK2 of FIG. 16 is different from the second bank BK2 of FIG. 12 only in that the processing units PU connected to one bank is plural, and most of the descriptions with reference to FIG. 12 may be applied equally. Hereinafter, mostly the differences regarding to the plurality of processing units PU will be described, and duplicate description will be shortened or omitted.

Referring to FIG. 16, a plurality of processing units PU may be connected to the second bank BK2. The plurality of processing units PU may be connected to a sense amplifier S/A. The second bank BK2 is shown as including a plurality of processing units PU in FIG. 16, but the embodiments are not limited thereto. Depending on embodiments, the plurality of processing units PU may be a component separate from the second bank BK2.

The plurality of processing units PU may include a logic circuit performing a computation. Each the plurality of processing units PU may perform a computation using data detected and amplified through the sense amplifier S/A. According to the above, since the speed of access to SRAM cell is faster than the speed access to DRAM cell, the plurality of processing units PU may use the second bank BK2, which includes the second memory cell array MCA2 including SRAM cells, as cache memory.

The memory cell array MCA of the second bank BK2 may include a plurality of second memory cell arrays MCA2. The memory cell array MCA of the second bank BK2 may include a plurality of rows R1 and R2. For example, each of the plurality of rows R1 and R2 may include two second memory cell array MCA2, but not limited thereto. The number of second memory cell array MCA2 included in one row may be modified variously. FIG. 16 shows the number of rows are two, but embodiments are not limited thereto, the number of rows consisting of the second memory cell arrays MCA2 may be modified variously.

Each of the plurality of processing units PU may perform computations for each row consisting of the second memory cell arrays MCA2. Each of the plurality of processing units PU may perform computations on each of the plurality of rows R1 and R2. That is, one processing unit PU may perform a computation on one row. The plurality of processing units PU may parallelly perform computations on the plurality of rows R1 and R2.

In some embodiments, the number of the processing unit PU connected to the second bank BK2 may be equal to the number of rows consisting of the second memory cell array MCA2 included in second bank BK2. However, the embodiments are not limited thereto. For example, one processing unit PU may perform a computation on a plurality of rows. In this case, the number of processing units PU may be less than the number of rows.

In some embodiments, each of the plurality of processing units PU may store the computation result in the second memory cell array MCA2 of each of the plurality of rows R1 and R2. For example, the plurality of computation results stored in the second memory cell array MCA2 of each row R1 and R2 may be output to the host through the buffer BF. The plurality of computation results may be output at once, or may be output sequentially several times. In some embodiments, only some of the plurality of computation results may be output. For example, the computation results stored in the second memory cell array MCA2 may be used for subsequent computations of the processing unit PU.

However, the embodiments are not limited to the above. Depending on embodiments, the processing unit PU may be connected to the buffer BF. In this case, each of the plurality of processing units PU may perform a computation using data stored in the buffer BF. Each of the plurality of processing units PU may store the computation result in the buffer BF.

FIG. 16 shows that the second bank BK2 includes only the second memory cell array MCA2, and FIG. 12 shows that the first bank BK1 includes only the first memory cell array MCA1, but the embodiments are not limited thereto. For example, the second bank BK2 may further include the first memory cell array MCA1. In this case, the semiconductor memory device (such as semiconductor memory device 20 in FIG. 15) may perform data read/write operations for the second bank BK2 and the fourth bank BK4 using the first memory cell array MCA1, and may perform a computation using the second memory cell array MCA2. In this regard, the above description with reference to FIG. 2 may be applied identically or similarly. As another example, the first bank BK1 may further include a second memory cell array MCA2. In this case, the semiconductor memory device 20 may use the second memory cell array MCA2 if high-speed read/write operations are required for the first bank BK1 and the third bank BK3.

In some embodiments, the plurality of banks BK1, BK2, BK3, BK4 of the semiconductor memory device 20 may include a first bank BK1 and a third bank BK3 including first memory cell array MCA1 including DRAM cells, and a second bank BK2 and a fourth bank BK4 including second memory cell array MCA2 including SRAM cells. The processing unit PU may not be connected to the first bank BK1 and the third bank BK3. A plurality of first processing unit PU1 may be connected to the second bank BK2, and a plurality of second processing unit PU2 may be connected to the fourth bank BK4. Each of the plurality of first processing unit PU1 may perform computations on each of the plurality of rows R1 and R2, which consist of the plurality of second memory cell arrays MCA2 of the second bank BK2. Each of the plurality of second processing units PU2 may perform computations on each of the plurality of rows R1 and R2, which consist of the plurality of second memory cell arrays MCA2 of the fourth bank BK4.

The semiconductor memory device 20 may use the second bank BK2 and the fourth bank BK4 not only for computation operations but also for general data read/write operations. For example, the semiconductor memory device 20 may store not only the data used for a computation but also the data used for execution of applications requiring high-speed read/write operations in the second bank BK2 and the fourth bank BK4.

In some embodiments, the memory controller (such as memory controller 10 in FIG. 15) and the semiconductor memory device 20 may be connected through one channel. In this case, the semiconductor memory device 20 may use all of the plurality of banks BK1, BK2, BK3, BK4 in a first mode of reading and writing data, and may use the second bank BK2 and the fourth bank BK4, which include the second memory cell array MCA2 and are connected to the processing unit PU, among the plurality of banks BK1, BK2, BK3, BK4 in a second mode of computation using the processing unit PU.

However, the embodiments are not limited thereto. Depending on embodiments, the memory controller 10 and the semiconductor memory device 20 may be connected through two channels. For example, the memory controller 10 may be connected by a first channel to first bank BK1 and third bank BK3 including first memory cell array MCA1, and may be connected by a second channel to the second bank BK2 and fourth bank BK4 which include the second memory cell array MCA2 and are connected to the processing unit PU. The semiconductor memory device 20 may simultaneously control the banks connected to the first channel and the banks connected to the second channel in different modes.

Referring to FIG. 17, plurality of banks BK1, BK2, BK3, BK4 may be disposed on a substrate 100. For example, the first bank BK1 and the third bank BK3 may be arranged along the first direction X. The second bank BK2 and the fourth bank BK4 may be arranged along the first direction X. The first bank BK1 and the second bank BK2 may be arranged along the second direction Y intersecting the first direction X. Third bank BK3 and the fourth bank BK4 may be arranged along the second direction Y. The second direction Y may be, for example, a direction perpendicular to the first direction X.

The peripheral circuit MD may be disposed between the plurality of banks BK1, BK2, BK3, BK4. The peripheral circuit MD may be disposed between the first bank BK1 and the second bank BK2, and between the third bank BK3 and the fourth bank BK4. The peripheral circuit MD may be disposed in a region extending along the first direction X. The first bank BK1 and the third bank BK3 are disposed at one side of the peripheral circuit MD in the second direction Y, and the second bank BK2 and the fourth bank BK4 are disposed at the other side (e.g., opposite side) in the second direction Y.

However, not limited thereto, as the embodiment of FIG. 9, the peripheral circuit MD may be split into a first peripheral circuit MD1 and a second peripheral circuit MD2 to be arranged spaced apart from each other with the plurality of banks BK1, BK2, BK3, BK4 interposed therebetween. For example, the first peripheral circuit MD1 may be disposed at an upper side of the first bank BK1 and the third bank BK3, and the second peripheral circuit MD2 may be disposed at a lower side of the second bank BK2 and the fourth bank BK4.

In some embodiments, the first bank BK1 and the third bank BK3 may include a first memory cell array MCA1 including the DRAM cell, and the second bank BK2 and the fourth bank BK4 may include a second memory cell array MCA2 including the SRAM cell.

In some embodiments, the plurality of processing units PU may be disposed inside the second bank BK2 and fourth bank BK4 including the second memory cell array MCA2. For example, a plurality of first processing units PU1 may be disposed inside the second bank BK2, and a plurality of second processing units PU2 may be disposed inside the fourth bank BK4.

The second bank BK2 will be described below, and the descriptions to be described below may be equally applied to the fourth bank BK4.

The second bank BK2 may include a plurality of second memory cell arrays MCA2. The plurality of second memory cell arrays MCA2 may be disposed in a form of an array including a plurality of rows R1, R2, and R3. While FIG. 17 shows three rows are in the second bank BK2, not limited thereto, the number of rows may be modified variously.

In some embodiments, in the second bank BK2, a plurality of first processing units PU1 may be disposed adjacent to each of the plurality of rows R1, R2, and R3. The plurality of first processing unit PU1 may be disposed alternately with the plurality of rows R1, R2, and R3. Each of the plurality of first processing units PU1 may perform a computation using data stored in the second memory cell array MCA2 consisting of an adjacent row.

While FIG. 17 shows that three first processing units PU1 are disposed in the second bank BK2, the embodiments are not limited thereto. The number of the first processing units PU1 disposed in second bank BK2 may be modified variously. For example, the first processing unit PU1 less than the number of rows may be disposed in the second bank BK2, and in this case, one first processing unit PU1 may process a computation using the data stored in the second memory cell array MCA2 consisting of the plurality of rows.

In some embodiments, the plurality of banks BK1, BK2, BK3, BK4 may have an asymmetric structures with respect to the peripheral circuit MD. For example, the first bank BK1 and the third bank BK3 which include the first memory cell array MCA1 may be arranged to face the second bank BK2 and fourth bank BK4 which including second memory cell array MCA2, with a peripheral circuit MD interposed therebetween. However, not to limited thereto, the plurality of banks BK1, BK2, BK3, BK4 may have symmetric structures with respect to the peripheral circuit MD. For example, the first bank BK1 and the third bank BK3 which include the first memory cell array MCA1 may be disposed to face each other with a peripheral circuit MD interposed therebetween, and the second bank BK2 and the fourth bank BK4 which include the second memory cell array MCA2 are disposed to face each other with a peripheral circuit MD interposed therebetween.

According to some embodiments, the plurality of banks BK1, BK2, BK3, BK4 includes a plurality of banks including a first bank BK1, a second bank BK2, and the processing unit PU. The first bank BK1 includes a first memory cell array MCA1 including a DRAM cell. The second bank BK2 includes a second memory cell array MCA2. The processing unit PU is adjacent to the second memory cell array MCA2. Accordingly, the semiconductor memory device 20 may store data used for computation directly in the second memory cell array MCA2, rather than through the first memory cell array MCA1, and may performs a computation using the data stored in the second memory cell array MCA2 through the processing unit PU. According to this, since the number of read/write operations of the semiconductor memory device 20 is reduced, which power consumption can be reduced and operating process speed can be increased.

According to some embodiments, since the second bank BK2 includes a plurality of second memory cell arrays MCA2 arranged in an array form including a plurality of rows, and a plurality of processing units PU disposed alternately with a plurality of rows in the second bank BK2, the semiconductor memory device 20 may parallelly perform computations for each plurality of rows using a plurality of processing units PU, which can increase operating process speed.

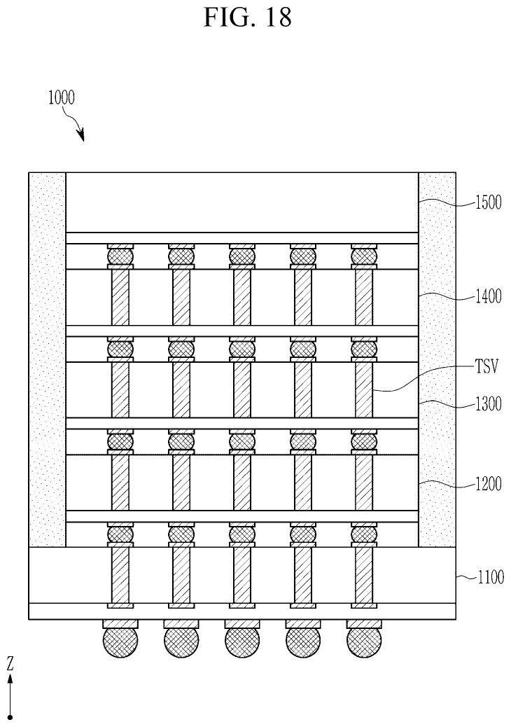

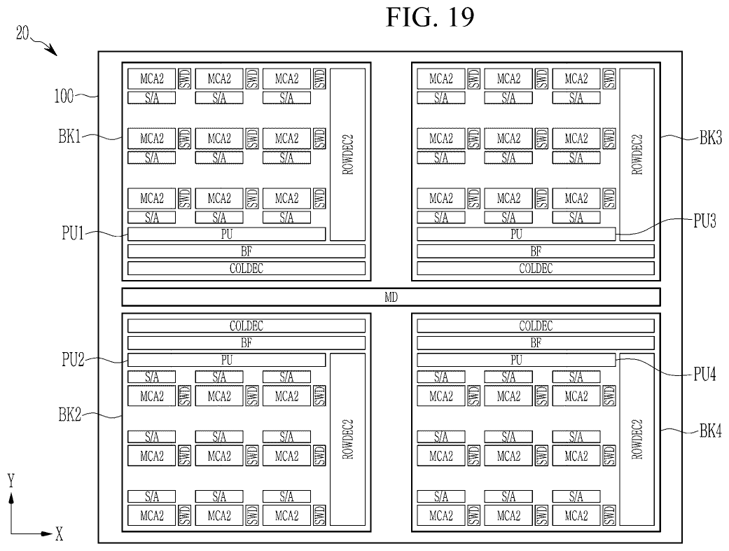

Hereinafter, a semiconductor memory device according to some embodiments is described with reference to FIG. 18 and FIG. 19.

FIG. 18 is a cross-sectional view of a semiconductor memory device according to some embodiments. FIG. 19 is a top plan view illustrating a layout of the components of a first core die according to some embodiments of FIG. 18.

Referring to FIG. 18, a semiconductor memory device according to some embodiments may be a high bandwidth memory (HBM) device 1000. The high bandwidth memory device 1000 may include a buffer die 1100 and a plurality of core dies 1200, 1300, 1400, 1500. For example, the plurality of core dies 1200, 1300, 1400, 1500 may include a first core die 1200, a second core die 1300, a third core die 1400, and a fourth core die 1500. While FIG. 18 shows a four core dies, not limited thereto, the number of core dies may be modified variously.

The buffer die 1100 and the plurality of core dies 1200, 1300, 1400, 1500 may be stacked in the third direction Z. The buffer die 1100 may be disposed at the lowest, and the plurality of core dies 1200, 1300, 1400, 1500 may be stacked on the buffer die 1100 in the third direction Z. For example, the third direction Z may be a direction perpendicular to the first direction X and the second direction Y in the previous drawings (direction perpendicular to an upper surface of the substrate).

The buffer die 1100 may receive commands, addresses, and/or data from an external host. The buffer die 1100 and the plurality of core dies 1200, 1300, 1400, 1500 may be connected through a penetrating silicon via TSV. The buffer die 1100 may transmit commands, addresses, and/or data received from the host to the plurality of core dies 1200, 1300, 1400, 1500 through the penetrating silicon via TSV.

The buffer die 1100 may include a memory controller according to some embodiments. The memory controller according to some embodiments may be any one of the memory controllers 10 according to the various embodiments described with reference to FIG. 1 to FIG. 17.

However, the embodiments are not limited to that the buffer die 1100 includes a memory controller. Depending on embodiments, the memory controller may be provided separately from the high bandwidth memory device 1000. For example, the memory controller may be provided inside the host.

Each of the plurality of core dies 1200, 1300, 1400, 1500 may be a semiconductor memory device. Each of the plurality of core dies 1200, 1300, 1400, 1500 may include a plurality of banks and peripheral circuits. The peripheral circuit may be disposed between the plurality of banks (e.g., in the center of the core die) or may be disposed outside the plurality of banks (e.g., at an edge portion of the core die). For example, the peripheral circuit may include a control logic circuit and an input/output circuit. The penetrating silicon via TSV connecting between the plurality of core dies 1200, 1300, 1400, 1500 and between the plurality of core dies 1200, 1300, 1400, 1500 and the buffer die 1100 can be connected to the input/output circuit. The control logic may control to perform operations on the plurality of banks, based on commands, addresses, and/or data received through the penetrating silicon via TSV and input/output circuit.

At least one of the plurality of core dies 1200, 1300, 1400, 1500 may be a semiconductor memory device according to some embodiments. A semiconductor memory device according to some embodiments may be any one of the semiconductor memory devices 20 according to the various embodiments described with reference to FIG. 1 to FIG. 17.

In a semiconductor memory device according to some embodiments, a plurality of banks may include a first bank including a first memory cell array including DRAM cell and a second bank including a second memory cell array including SRAM cell. A semiconductor memory device according to some embodiments may include a processing unit, and the processing unit may be disposed adjacent to the second memory cell array. A semiconductor memory device according to some embodiments may be referred to as a hybrid PIM. In contrast, a semiconductor memory device whose plurality of banks includes a first bank including a first memory cell array including DRAM cell and does not include a second bank including a second memory cell array including SRAM cell is referred to as DRAM. Also, a semiconductor memory device whose plurality of banks includes a second bank including a second memory cell array including SRAM cell and does not include a first bank including a first memory cell array including DRAM cell is referred to as SRAM.

In some embodiments, the plurality of core dies 1200, 1300, 1400, 1500 may include at least one hybrid PIM and at least one DRAM. For example, the hybrid PIM may be stacked closer than to the DRAM to the buffer die 1100. Among the plurality of core dies 1200, 1300, 1400, 1500, the number of hybrid PIMs, the number of DRAMs, and/or the stacking order of hybrid PIMs and DRAMs may be modified variously.

In some embodiments, the plurality of core dies 1200, 1300, 1400, 1500 may include at least one hybrid PIM and at least one SRAM. For example, the hybrid PIM may be stacked closer than to the SRAM to the buffer die 1100. Among the plurality of core dies 1200, 1300, 1400, 1500, the number of hybrid PIMs, the number of SRAMs, and/or the stacking order of hybrid PIMs and SRAMs may be modified variously.

In some embodiments, the plurality of core dies 1200, 1300, 1400, 1500 may include at least one hybrid PIM, at least one DRAM and at least one SRAM. For example, the hybrid PIM may be stacked closer than to the DRAM and the SRAM to the buffer die 1100. Among the plurality of core dies 1200, 1300, 1400, 1500, the number of hybrid PIMs, the number of DRAMs, the number of SRAMs and/or the stacking order of hybrid PIMs, DRAMs and SRAMs may be modified variously.

According to some embodiments, since at least one core die of the high bandwidth memory device 1000 is implemented with a hybrid PIM, the operating process speed of the high bandwidth memory device 1000 can be increased.

Meanwhile, unlike the hybrid PIM embodiments shown in FIG. 1 to FIG. 17, a semiconductor memory device whose the plurality of banks respectively include a processing unit and a second memory cell array including SRAM cell and do not include a first memory cell array including DRAM cell may be referred to as SRAM PIM.

In some embodiments, the plurality of core dies 1200, 1300, 1400, 1500 may include at least one SRAM PIM and at least one DRAM. For example, the SRAM PIM may be stacked closer than to the DRAM to the buffer die 1100. Among the plurality of core dies 1200, 1300, 1400, 1500, the number of SRAM PIMs, the number of DRAMs, and/or the stacking order of SRAM PIMs and DRAMs may be modified variously.

According to some embodiments, since at least one core die is implemented with SRAM PIM and at least one core die is implemented with DRAM, the operating process speed of the high bandwidth memory device 1000 may be increased.

While the embodiments that have at least one core die as a hybrid PIM provides a high bandwidth memory device 1000 with a hybrid PIM implemented at bank level, the embodiments in which at least one core die is a SRAM PIM and at least one core die is a DRAM may provide a high bandwidth memory device 1000 with hybrid PIM implemented at die level.

Hereinafter, a first core die 1200 implemented with SRAM PIM will be described with reference to FIG. 19.

FIG. 19 is a top plan view illustrating a layout of the components of a first core die 1200 according to some embodiments of FIG. 18.

Referring to FIG. 19, the first core die 1200 may include a plurality of banks BK1, BK2, BK3, BK4, a peripheral circuit MD, and a plurality of processing units PU1, PU2, PU3, PU4. The description with reference to FIG. 12 may be equally applied to each of the plurality of banks BK1, BK2, BK3, BK4.

A plurality of banks BK1, BK2, BK3, BK4 may be disposed on substrate 100. For example, the first bank BK1 and the third bank BK3 may be arranged along the first direction X. The second bank BK2 and the fourth bank BK4 may be arranged along the first direction X. The first bank BK1 and the second bank BK2 may be arranged along the second direction Y intersecting the first direction X. The third bank BK3 and the fourth bank BK4 can be arranged along the second direction Y. The second direction Y may be, for example, a direction perpendicular to the first direction X.

The peripheral circuit MD may be disposed between the plurality of banks BK1, BK2, BK3, BK4. The peripheral circuit MD may be disposed between the first bank BK1 and the second bank BK2, and between the third bank BK3 and the fourth bank BK4. The peripheral circuit MD may be disposed in a region extending along the first direction X. The first bank BK1 and the third bank BK3 are disposed at one side of the peripheral circuit MD in the second direction Y, and the second bank BK2 and the fourth bank BK4 are disposed at the other side (e.g., opposite side) in the second direction Y.

However, not limited thereto, as the embodiment of FIG. 9, the peripheral circuit MD may be split into a first peripheral circuit MD1 and a second peripheral circuit MD2 to be arranged spaced apart from each other with the plurality of banks BK1, BK2, BK3, BK4 interposed therebetween. For example, the first peripheral circuit MD1 may be disposed at an upper side of the first bank BK1 and the third bank BK3, and the second peripheral circuit MD2 may be disposed at a lower side of the second bank BK2 and the fourth bank BK4.

In some embodiments, each of the plurality of banks BK1, BK2, BK3, BK4 may include a second memory cell array MCA2 including an SRAM cell, and may not include a first memory cell array MCA1 including a DRAM cell.

In some embodiments, the plurality of processing units PU1, PU2, PU3, PU4 may be disposed inside the plurality of banks BK1, BK2, BK3, BK4 including the second memory cell array MCA2. For example, the first processing unit PU1 may be disposed inside the first bank BK1, the second processing unit PU2 may be disposed inside the second bank BK2, the third processing unit PU3 may be disposed inside the third bank BK3, and the fourth processing unit PU4 may be disposed inside the fourth bank BK4.

However, the embodiments are not limited to the processing unit PU being disposed inside the bank. In some embodiments in which a processing unit PU is disposed outside or external to the bank, the first processing unit PU1 may be disposed between the first bank BK1 and the peripheral circuit MD, and the second processing unit PU2 may be disposed between the second bank BK2 and the peripheral circuit MD, the third processing unit PU3 may be disposed between the third bank BK3 and the peripheral circuit MD, and the fourth processing unit PU4 may be disposed between the fourth bank BK4 and the peripheral circuit MD.

According to some embodiments, each of the plurality of banks BK1, BK2, BK3, BK4 of the first core die 1200 may include a second memory cell array MCA2 including the SRAM cell and a processing unit PU, and may not include the first memory cell array MCA1 including the DRAM cell having slower speed than the SRAM cell. The high bandwidth memory device 1000 of FIG. 18, which includes the first core die 1200 of FIG. 19 and other core dies implemented with DRAM, stores data used for computation directly in the first core die 1200 including the SRAM cell, rather than through other core dies including the DRAM cell, and performs a computation through processing unit PU inside the first core die 1200. According to this, the number of data transfer between core dies may be reduced, and the data transfer path may be shortened, thereby the power consumption of the high bandwidth memory device 1000 can be reduced and the operating process speed can be increased.

Although the embodiments of the present disclosure have been described in detail above, the scope of the present disclosure is not limited thereto, and various modifications and improvements can be made by those skilled in the art using the basic concept of the present disclosure defined in the following claims, and they fall within the scope of the present disclosure.

What is claimed is:

1. A semiconductor memory device comprising:
a substrate;
a plurality of banks comprising a first bank comprising a first memory cell array comprising DRAM cells, and a second bank comprising a second memory cell array comprising SRAM cells, on the substrate;
a peripheral circuit between the plurality of banks; and
a processing unit adjacent to the second memory cell array.

2. The semiconductor memory device of claim 1 wherein the semiconductor memory device comprises a plurality of processing units,
wherein each of the plurality of banks comprises the first memory cell array and the second memory cell array, and
wherein respective ones of the plurality of processing units including the processing unit are closer to the second memory cell array of a respective one of the plurality of banks than to the first memory cell array of a respective one of the plurality of banks.

3. The semiconductor memory device of claim 1 wherein the second memory cell array is closer than the first memory cell array to the peripheral circuit, and
wherein the processing unit is between the second memory cell array and the peripheral circuit.

4. The semiconductor memory device of claim 1, wherein some of the plurality of banks are at a first side of the peripheral circuit and some of the plurality of banks are at a second side of the peripheral circuit which is opposite of the first side.

5. The semiconductor memory device of claim 1, wherein the peripheral circuit comprises a first peripheral circuit and a second peripheral circuit, and
wherein the plurality of banks are between the first peripheral circuit and the second peripheral circuit.

6. The semiconductor memory device of claim 1, wherein the first bank comprises the first memory cell array and is free of SRAM cells, and
wherein the second bank comprises the second memory cell array, and is free of DRAM cells.

7. The semiconductor memory device of claim 6, wherein the peripheral circuit is between the first bank and the second bank.

8. The semiconductor memory device of claim 6, wherein the semiconductor memory device comprises a plurality of first banks including the first bank and a plurality of second banks including the second bank,
wherein some of the plurality of first banks are at a first side of the peripheral circuit and some of the plurality of first banks are at a second side of the peripheral circuit which is opposite of the first side, and
wherein some of the plurality of second banks are at the first side and some of the plurality of second banks are at a second side of the peripheral circuit which is opposite of the first side.

9. The semiconductor memory device of claim 1, wherein the semiconductor memory device comprises a plurality of second memory cell arrays including the second memory cell array and a plurality of processing units including the processing unit,
wherein the plurality of second memory cell arrays are on the substrate in an array comprising a plurality of rows, and
wherein the plurality of processing units are alternately arranged with the plurality of rows.

10. The semiconductor memory device of claim 1, wherein a DRAM cell of the DRAM cells comprises:
a DRAM cell transistor; and
a capacitor connected to the DRAM cell transistor,
wherein the DRAM cell transistor comprises a metal oxide field effect transistor,
wherein a SRAM cell of the SRAM cells comprises:
a first inverter and a second inverter coupled in parallel between a power terminal and a ground terminal; and
a first pass gate transistor and a second pass gate transistor connected to respective output terminals of the first inverter and the second inverter,
wherein the first inverter comprises a first pull-up transistor and a first pull-down transistor coupled in series, and
wherein the second inverter comprises a second pull-up transistor and a second pull-down transistor coupled in series.

11. The semiconductor memory device of claim 1, wherein a DRAM cell of the DRAM cells comprises a DRAM cell transistor;
wherein the DRAM cell transistor comprises a ferroelectrics field effect transistor;
wherein a SRAM cell of the SRAM cells comprises:
a first inverter and a second inverter coupled in parallel between a power terminal and a ground terminal; and
a first pass gate transistor and a second pass gate transistor connected to respective output terminals of the first inverter and the second inverter,
wherein the first inverter comprises a first pull-up transistor and a first pull-down transistor coupled in series, and
wherein the second inverter comprises a second pull-up transistor and a second pull-down transistor coupled in series.

12. The semiconductor memory device of claim 11, wherein the DRAM cell transistor comprises:
a first active pattern having a first fin;
a first gate electrode on the first active pattern;
a ferroelectrics layer between the first active pattern and the first gate electrode; and
first source/drain patterns on opposing sides of the first active pattern;
wherein at least one of the first pass gate transistor, the second pass gate transistor, the first pull-up transistor, the first pull-down transistor, the second pull-up transistor, and the second pull-down transistor comprises:
a second active pattern having a second fin;
a second gate electrode on the second active pattern; and
second source/drain patterns on opposing sides of the second active pattern, and
wherein a height of the first fin of the first active pattern is equal to a height of the second fin of the second active pattern, relative to the substrate.

13. The semiconductor memory device of claim 1, further comprising:
a plurality of first bit lines intersecting the first memory cell array in a first direction parallel to an upper surface of the substrate; and
a plurality of second bit lines and a plurality of dummy lines intersecting the second memory cell array in the first direction,
wherein first ones of the plurality of first bit lines are aligned with the plurality of second bit lines along the first direction,
wherein second ones of the plurality of first bit lines are aligned with the plurality of dummy lines along the first direction, and
wherein the plurality of first bit lines are electrically connected to the first memory cell array, the plurality of second bit lines are electrically connected to the second memory cell array, and the plurality of dummy lines are electrically isolated from the second memory cell array.

14. A semiconductor memory device comprising:
a substrate;
a plurality of banks on the substrate and comprising a first bank comprising a first memory cell array comprising plurality of first cells and a second bank comprising a second memory cell array comprising a plurality of second cells;
a peripheral circuit between the plurality of banks; and
a processing unit adjacent to the second memory cell array,
wherein a number of the plurality of second cells is less than a number of the plurality of first cells, and
wherein each of the plurality of second cell is smaller in size than each of the plurality of first cells.

15. The semiconductor memory device of claim 14, wherein each of the plurality of first cells comprises a DRAM cell, and
wherein each of the plurality of second cells comprises an SRAM cell.

16. The semiconductor memory device of claim 14, wherein each of the plurality of banks comprises the first memory cell array and the second memory cell array,
wherein the second memory cell array is closer than the first memory cell array to the peripheral circuit; and
wherein the processing unit is between the second memory cell array and the peripheral circuit.

17. The semiconductor memory device of claim 14, wherein the first bank comprises the first memory cell array and is free of the second cells; and
wherein the second bank comprises the second memory cell array, and is free of the first cells.

18. The semiconductor memory device of claim 17, wherein the first bank is at a first side of the peripheral circuit and the second bank is at a second side of the peripheral circuit which is opposite of the first side.

19. The semiconductor memory device of claim 17, wherein the semiconductor memory device comprises a plurality of second memory cell arrays including the second memory cell array and a plurality of processing units including the processing unit,
wherein the plurality of second memory cell arrays are on the substrate in an array comprising a plurality of rows, and
wherein each of the plurality of processing units is in the second bank and adjacent to a respective one of the plurality of rows.

20. A memory system comprising:
a semiconductor memory device comprising:
a plurality of banks comprising a first bank comprising a first memory cell array comprising a DRAM cell, and a second bank comprising a second memory cell array comprising an SRAM cell; and
a processing unit adjacent to the second memory cell array; and
a memory controller configured to control operations of the semiconductor memory device.
